(19) United States
(12) Patent Application Publication
(10) Pub. No.: US 2017/0346728 A1
(43) Pub. Date: Nov. 30, 2017

(54) CONTROL APPARATUS, CONTROL METHOD AND RECORDING MEDIUM WITH CONTROL PROGRAM RECORDED THEREON

(71) Applicant: FUJITSU LIMITED, Kawasaki-shi (JP)

(72) Inventors: Haruka Shinohara, Yokohama (JP); Masakazu Bamba, Kawasaki (JP)

(73) Assignee: FUJITSU LIMITED, Kawasaki-shi (JP)

(21) Appl. No.: 15/581,773

(22) Filed: Apr. 28, 2017

(30) Foreign Application Priority Data
May 30, 2016 (JP) 2016-107410

(51) Int. Cl. H04L 12/703; H04L 12/721; H04J 14/02; H04Q 11/00; H04L 12/24

(52) U.S. Cl. CPC H04L 45/28; H04Q 11/0066; H04L 41/069; H04L 41/0816; H04J 14/0227; H04L 45/62; H04Q 2011/0016; H04Q 2011/0073; H04Q 2011/0081

(57) ABSTRACT

A control apparatus configured to transmit first settings information including first settings contents with respect to an optical transmission device. The control apparatus includes a processor and a storage. The processor is configured to receive a setting error with respect to the first settings information from the optical transmission device, store a setting condition of the optical transmission device that is acquired from the setting error in the storage, determine second settings contents relating to transmission of an optical signal with respect to the optical transmission device based on the stored setting condition, and transmit second settings information including the second settings contents to the optical transmission device.

### CROSS-REFERENCE TO RELATED APPLICATION

This application is based upon and claims the benefit of priority of the prior Japanese Patent Application No. 2016-107410, filed on May 30, 2016, the entire contents of which are incorporated herein by reference.

### FIELD

The present invention relates to a control apparatus, a control method and a control program.

### BACKGROUND

FIG. 34 is a diagram that illustrates an example of a system configuration of an optical transport network system P100. The optical transport network system P100 is a system that performs data transmission by means of optical signals using optical fibers. The optical transport network system P100 includes NEs (Network Elements) P3 that transmit optical signals, a path calculating apparatus P1 that performs path calculations, and an NMS (Network Management System) P2 that sets paths to the NEs P3.

The NE P3 is also referred to as an optical transport network apparatus. The NE P3 is, for example, a WDM (Wavelength Division Multiplex) device.

The path calculating apparatus P1 determines a route and a wavelength and the like of a path when a path is newly set between two locations. The NMS P2 transmits a command for setting a path to the NEs P3 based on the route and wavelength and the like of the path that is determined by the path calculating apparatus Pl. At this time, the NMS P2 generates and transmits the path setting command in accordance with a setting condition for the NEs P3 that is stored. In some cases, the NEs P3 have device configuration constraints that are specific to the respective NEs P3. The setting conditions for the NEs P3 include, for example, a constraint regarding optical cross-connect settings, a constraint regarding signal types that ports support, a wavelength constraint or the like.

### PATENT DOCUMENTS

[Patent document 1] Japanese Patent Laid-Open No. 2005-268932

[Patent document 2] Japanese Patent Laid-Open No. 2013-255163

However, when there is a bug in path calculation software that is installed in the path calculating apparatus P1 or the operator makes a mistake during operation or the like, there is a possibility that the NMS P2 will transmit a command for setting a path that it is not possible to set at an NE P3. In such a case, processing arises in which the relevant NE P3 returns an error to the NMS P2, and the path calculating apparatus P1 recalculates the path. In a case where a path is newly added between two locations also, there is the possibility that the NMS P2 will once again transmit a command for setting a path that it is not possible to set at the NE P3 in the same way. Consequently, it takes time to set a path.

### SUMMARY

One aspect of the present invention is a control apparatus configured to transmit first settings information including first settings contents with respect to an optical transmission device. The control apparatus includes a processor and a storage. The processor is configured to receive a setting error with respect to the first settings information from the optical transmission device, store a setting condition of the optical transmission device that is acquired from the setting error in the storage, determine second settings contents relating to transmission of an optical signal with respect to the optical transmission device based on the stored setting condition, and transmit second settings information including the second settings contents to the optical transmission device.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of the configuration of an optical transport network system according to a first embodiment;

FIG. 2 illustrates an example of the hardware configuration of a path calculating apparatus;

FIG. 3 is a diagram illustrating an example of the functional configuration of the path calculating apparatus and an SDN controller;

FIG. 4 illustrates an example of an optical cross-connect unsettable ports list;

FIG. 5 illustrates an example of an unsettable wavelengths list;

FIG. 6 illustrates an example of an unsettable signal types list;

FIG. 7 illustrates an example of an unsettable contents list;

FIG. 8 illustrates an example of a NE possession ports list;

FIG. 9 illustrates an example of a paths list;

FIG. 10 illustrates an example of an optical cross-connects list;

FIG. 11 illustrates an example of a links list;

FIG. 12 illustrates an example of an entire ports list;

FIG. 13A illustrates a flowchart of optical path setting processing of the path calculating apparatus;

FIG. 13B illustrates an example of processing for selecting a setting port of an optical path and transmitting a setting command for the optical path that is executed with respect to each NE on a candidate route of an optical path that is selected;

FIG. 14 illustrates an example of a flowchart of processing to update unsettable conditions lists of the path calculating apparatus;

FIG. 15 is a diagram illustrating the topology of an optical transport network system in a specific example;

FIG. 16 is a diagram illustrating an example of the hardware configuration of an NE #1 in the specific example;

FIG. 17 is a diagram illustrating an example of the hardware configuration of an NE #2 in the specific example;

FIG. 18 illustrates an example of the optical cross-connect unsettable ports list in an initial state;

FIG. 19 illustrates an example of the unsettable wavelengths list in an initial state;

FIG. 20 illustrates an example of the unsettable signal types list in an initial state;

FIG. 21 illustrates an example of the NE possession ports list in an initial state;

FIG. 22 illustrates an example of the paths list in an initial state;

FIG. 23 illustrates an example of the optical cross-connects list in an initial state;

FIG. 24 illustrates an example of the links list in an initial state;

FIG. 25 illustrates an example of the entire ports list in an initial state;

FIG. 26 is a diagram illustrating an example of a processing sequence when setting an optical path between the NE #1 and the NE #2 in an initial state of the optical transport network system in the specific example;

FIG. 27 is a diagram illustrating the optical transport network system according to the specific example after setting of the optical path between the NE #1 and the NE #2 illustrated in FIG. 26 is completed;

FIG. 28 is a diagram illustrating an example of the optical cross-connect unsettable ports list after setting of the optical path between the NE #1 and the NE #2 in FIG. 26 is completed;

FIG. 29 is a diagram illustrating an example of the paths list after setting of the optical path between the NE #1 and the NE #2 in FIG. 26 is completed;

FIG. 30 is a diagram illustrating an example of the optical cross-connects list after setting of the optical path between the NE #1 and the NE #2 in FIG. 26 is completed;

FIG. 31 is a diagram illustrating an example of the links list after setting of the optical path between the NE #1 and the NE #2 in FIG. 26 is completed;

FIG. 32 is a diagram illustrating an example of the entire ports list after setting of the optical path between the NE #1 and the NE #2 in FIG. 26 is completed;

FIG. 33 is a diagram illustrating an example of a processing sequence when setting an optical path between the NE #1 and the NE #2 once again after setting the optical path between the NE #1 and the NE #2 in FIG. 26 in the optical transport network system in the specific example;

FIG. 34 is a diagram illustrating an example of the system configuration of an optical transport network system; and

FIG. 35 is a diagram illustrating an example of the system configuration of an optical transport network system including NEs of different manufacturers.

### DESCRIPTION OF EMBODIMENT

Hereunder, an embodiment of the present invention is described based on the accompanying drawings. The configuration of the following embodiment is for the purpose of exemplification, and the present invention is not limited to the configuration of the embodiment.

### Reference Example

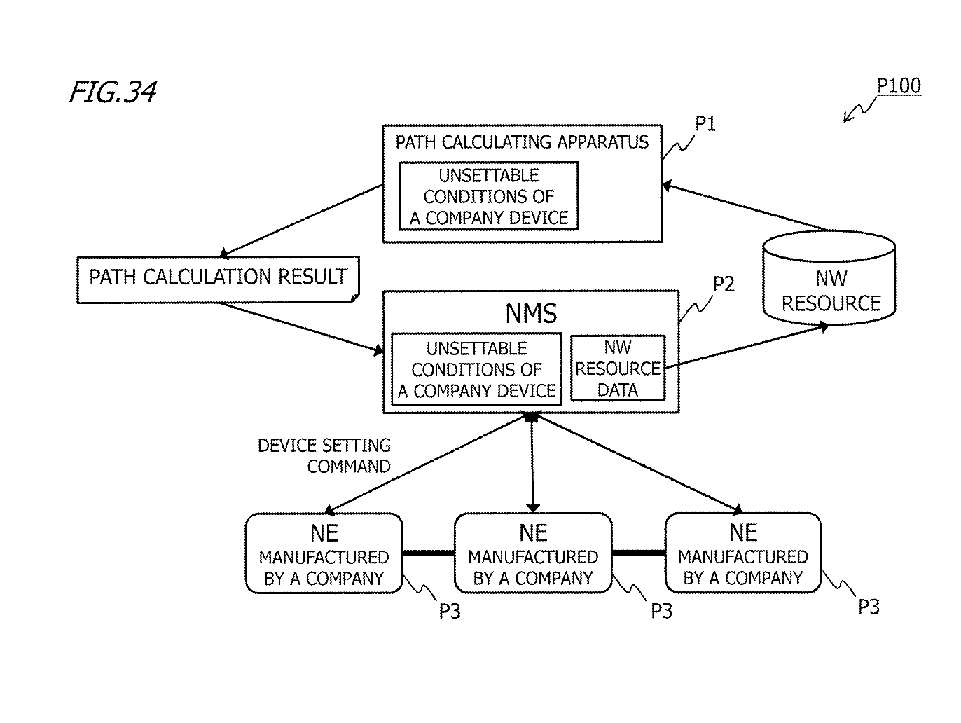

In some cases, the device configurations of NEs P3 differ depending on the manufacturers, and the device configuration constraints are thus also different. Therefore, in many cases the NEs P3 and path calculation software of the same manufacturer are used in an optical transport network system P100. In the optical transport network system P100 illustrated in FIG. 34 also, the NEs P3 and the path calculation software that are all manufactured by the same A company are used.

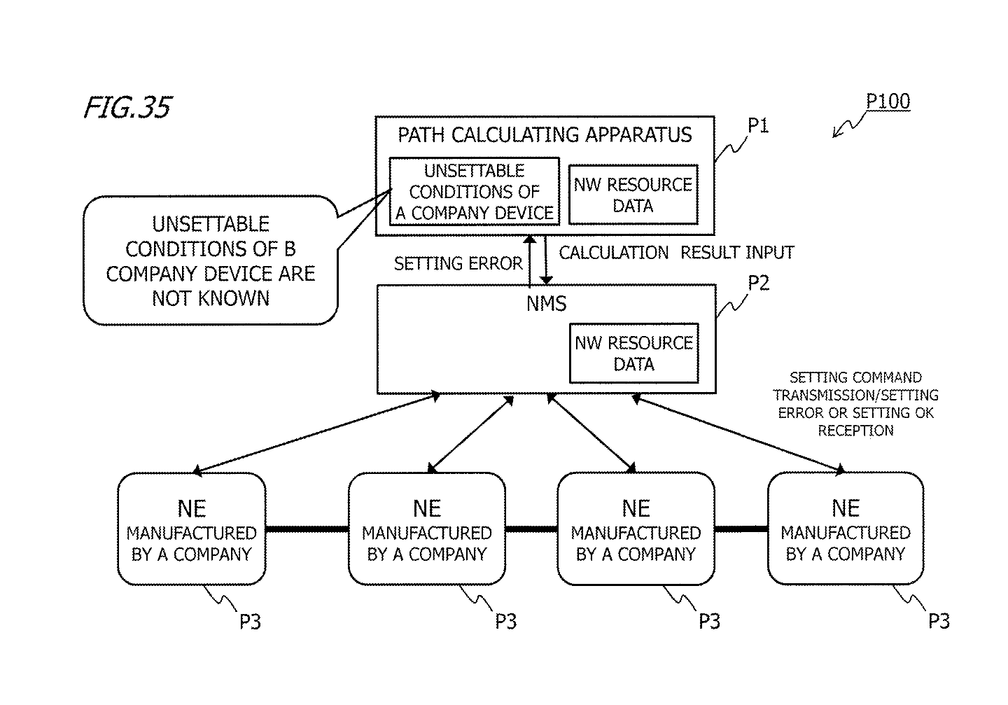

FIG. 35 is a diagram that illustrates an example of the system configuration of an optical transport network system P100 that includes NEs P3 made by different manufacturers. The example illustrated in FIG. 35 is an example in which an NE P3 manufactured by B company is added to the optical transport network system P100 that uses the NEs P3 manufactured by A company.

In the case of the example illustrated in FIG. 35, the path calculation software installed in the path calculating apparatus P1 has not ascertained device configuration constraints of the NE P3 manufactured by B company. Consequently, there is the possibility that the path calculating apparatus P1 will calculate a path that it is not possible for the NE P3 manufactured by B company to set, and the NMS P2 will transmit a command to set a path that it is not possible for the NE P3 manufactured by B company to set. In such a case, there is a high possibility that processing will occur in which an error is returned from the NE P3 to the NMS P2, and the path calculating apparatus P1 performs operations to recalculate a path. As a result, in addition to time being taken to set a path, there is the possibility of a problem arising with respect to the processing load in relation to the setting of the optical path, such as the number of commands increasing and thus placing pressure on the network bandwidth.

Further, by calculating a path and setting the NEs P3 in a manner that takes into consideration the device configuration constraints of each NE P3, an administrator can mix NEs P3 that are manufactured by different manufacturers on the network. However, it is difficult for an administrator to ascertain and take into consideration the device configuration constraints of the NEs P3 of a plurality of manufacturers as well as new manufacturers that are expected to appear in the future and also new NE P3 models, and to install such NEs P3.

### First Embodiment

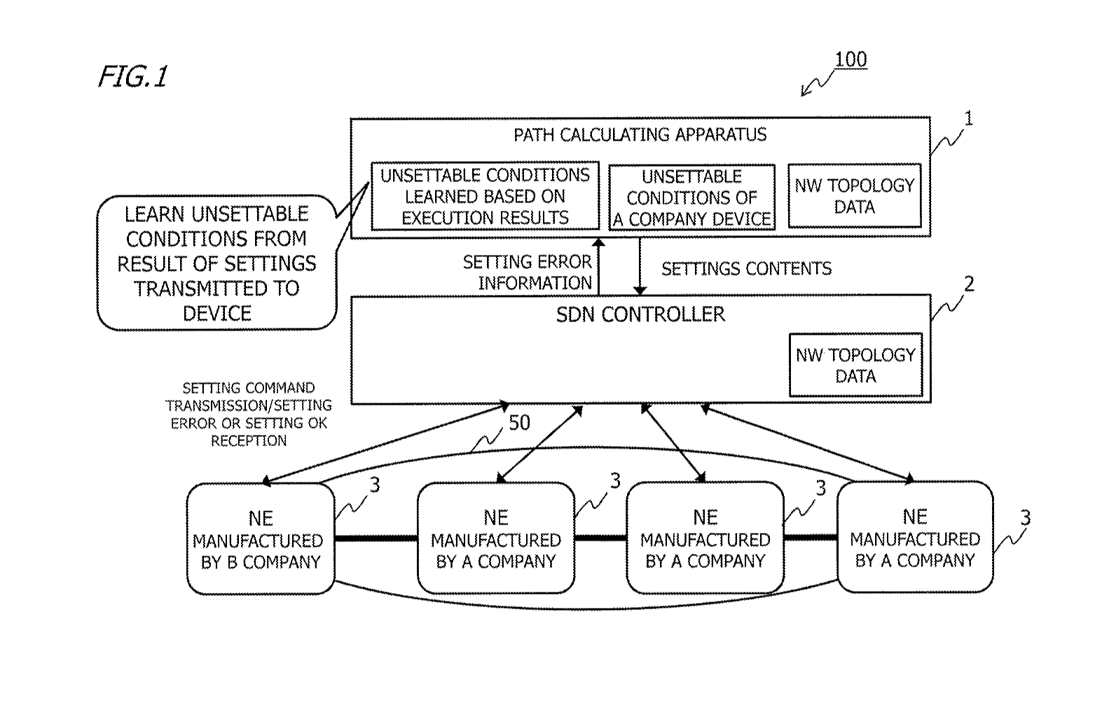

FIG. 1 is a diagram that illustrates an example of the configuration of an optical transport network system 100 according to a first embodiment. The optical transport network system 100 includes a path calculating apparatus 1, an SDN (Software Defined Network) controller 2 and a plurality of NEs 3. In the example illustrated in FIG. 1, one NE 3 is manufactured by B company, and the other NEs 3 are manufactured by A company. The NE 3 is, for example, a WDM device. It is assumed that NEs 3 of a plurality of manufacturers are mixed on the optical transport network system. The NE 3 is one example of an “optical transmission device”.

The plurality of NEs 3 are connected by optical fibers to form an optical transport network 50. Each NE 3 connects a network device (not illustrated) such as a router or switch that is under the command of the relevant NE 3.

The SDN controller 2 is a device of an NMS that controls the setting of optical paths of the NEs 3. In the first embodiment, OpenFlow is used for setting optical paths of the NEs 3. However, a method for setting optical paths of the NEs 3 is not limited to OpenFlow, and for example, an interface such as CLI (Command Line Interface), NETCONF (NETwork CONFiguration protocol) or TL1 (Transaction Language 1) may be used.

In the first embodiment, the term “optical path” refers to a transmission line between two NEs 3, and is defined by a route between NEs 3 at both ends, a signal type and a wavelength. An optical path is also called simply a “path”. Further, in the first embodiment, a route is defined by NEs 3 at both ends of an optical path and a relaying NE 3 or/and a link passing therethrough. Furthermore, in the first embodiment, the term “link” refers to a physical transmission line (optical fiber) that connects adjacent NEs 3.

The path calculating apparatus 1 is an apparatus that performs calculations with respect to optical paths inside the optical transport network 50. The path calculating apparatus 1 may be mounted in the same apparatus as the SDN controller 2, or may be mounted in a separate apparatus to the SDN controller 2. In the first embodiment, it is assumed that the path calculating apparatus 1 is mounted in the same apparatus as the SDN controller 2.

The path calculating apparatus 1 holds unsettable conditions of the NEs 3 of A company as well as topology data of the optical transport network 50. Upon an optical path setting request being input from outside, the path calculating apparatus 1 calculates a route of an optical path between the specified NEs 3 based on the unsettable conditions of the NEs 3 of A company as well as the topology data, determines settings contents for the NEs 3 on the route, and outputs the settings contents to the SDN controller 2. The SDN controller 2 transmits a setting command to the NEs 3 on the route of the optical path.

Upon receiving the setting command for the optical path from the SDN controller 2, each NE 3 performs settings for establishing the optical path in accordance with the setting command at a port within its own device. In a case where it is not possible for the NE 3 to set the contents of the setting command, the NE 3 transmits an optical path setting error to the SDN controller 2. For example, in the example illustrated in FIG. 1, when determining the route of the optical path and the settings contents for the NEs 3 on the route, although unsettable conditions of A company are taken into consideration, unsettable conditions of B company are not known and are therefore not taken into consideration, and hence there is a high possibility that there will be a setting error at the NE 3 manufactured by B company.

Upon receiving a setting error from an NE 3, the SDN controller 2 outputs the setting error to the path calculating apparatus 1. The setting error, for example, includes information such as a port of an optical cross-connect inside the NE 3 at which the setting error occurred, and the signal type or wavelength that is the cause of the setting error.

In the first embodiment, based on such setting errors, the path calculating apparatus 1 learns and stores conditions which make paths unsettable. Subsequently, in a case where a request to set an optical path is input, the path calculating apparatus 1 calculates the route of the optical path by also taking into consideration the unsettable path conditions that are learned. Thus, the probability of transmitting a setting command for an optical path that it is not possible for the NEs 3 to set can be lowered.

### Device Configuration

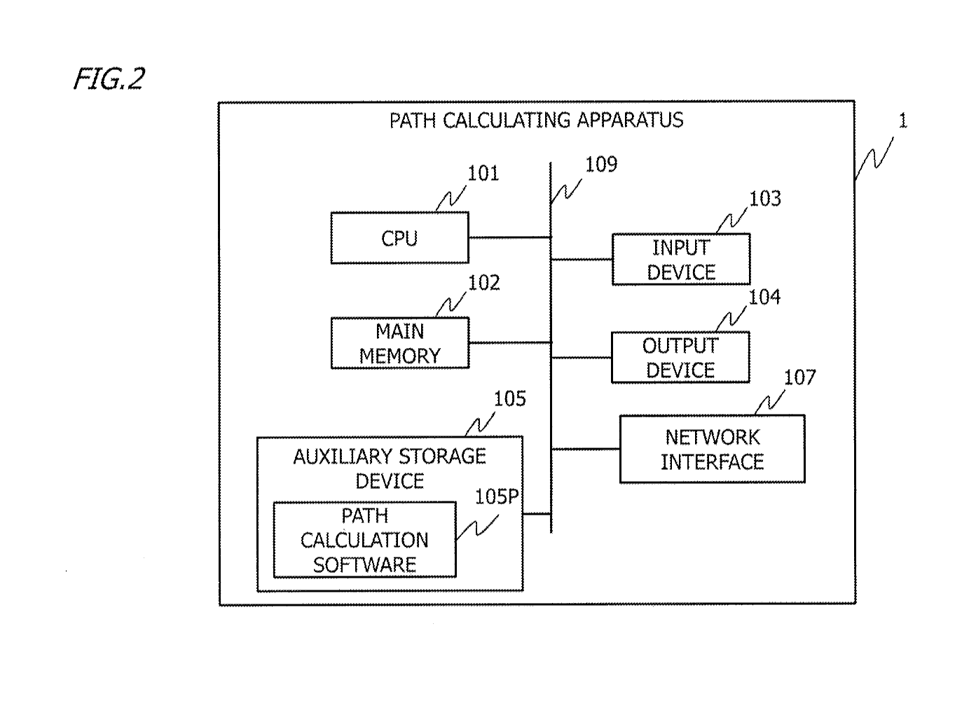

FIG. 2 illustrates an example of the hardware configuration of the path calculating apparatus 1. The path calculating apparatus 1 is, for example, a dedicated computer. The path calculating apparatus 1 is one example of a “control apparatus”.

The path calculating apparatus 1 includes a CPU (Central Processing Unit) 101, a main memory 102, an input device 103, an output device 104, an auxiliary storage device 105 and a network interface 107. These components are connected to each other by a bus 109.

The input device 103 is, for example, a keyboard, a mouse, operation buttons, a touch panel or a keypad. Data that is input from the input device 103 is output to the CPU 101.

The auxiliary storage device 105 stores an OS (Operating System), various programs, and data that the CPU 101 uses when executing respective programs. The auxiliary storage device 105 is, for example, a nonvolatile storage medium such as an EPROM (Erasable Programmable ROM), a flash memory or a hard disk drive. The auxiliary storage device 105, for example, stores path calculation software 105P. Further, in the first embodiment, since it is assumed that the path calculating apparatus 1 is mounted in the same apparatus as the SDN controller 2, the auxiliary storage device 105 also stores an SDN controller program.

The main memory 102 is a storage device that provides a storage area and a work area for loading a program stored in the auxiliary storage device 105 to the CPU 101, and that is used as a buffer. The main memory 102, for example, includes a semiconductor memory such as a ROM (Read Only Memory) or a RAM (Random Access Memory).

The CPU 101 executes various kinds of processing by loading the OS or various application programs stored in the auxiliary storage device 105 into the main memory 102 and executing the OS or application programs. The CPU 101 is not limited to a single CPU, and a plurality of CPUs may be provided.

The network interface 107 is an interface that performs operations to input and output information to and from a network. The network interface 107 may be an interface that connects with a wired network or may be an interface that connects with a wireless network. The network interface 107 is, for example, an NIC (Network Interface Card) or the like.

The output device 104 outputs the results of processing of the CPU 101. The output device 104 includes a display and/or a printer.

Note that, the hardware configuration of the path calculating apparatus 1 illustrated in FIG. 2 is one example, and the present invention is not limited to the above described hardware configuration, and components can be omitted, substituted or added as appropriate in accordance with the embodiment. For example, the path calculating apparatus 1 may include a removable recording medium driving device, and may execute a program recorded on a removable recording medium. The removable recording medium is a recording medium such as an SD card, a Mini SD card, a Micro SD card, a USB (Universal Serial Bus) flash memory, a CD (Compact Disc), a DVD (Digital Versatile Disc), a Blu-ray (registered trademark) disc, or a flash memory card.

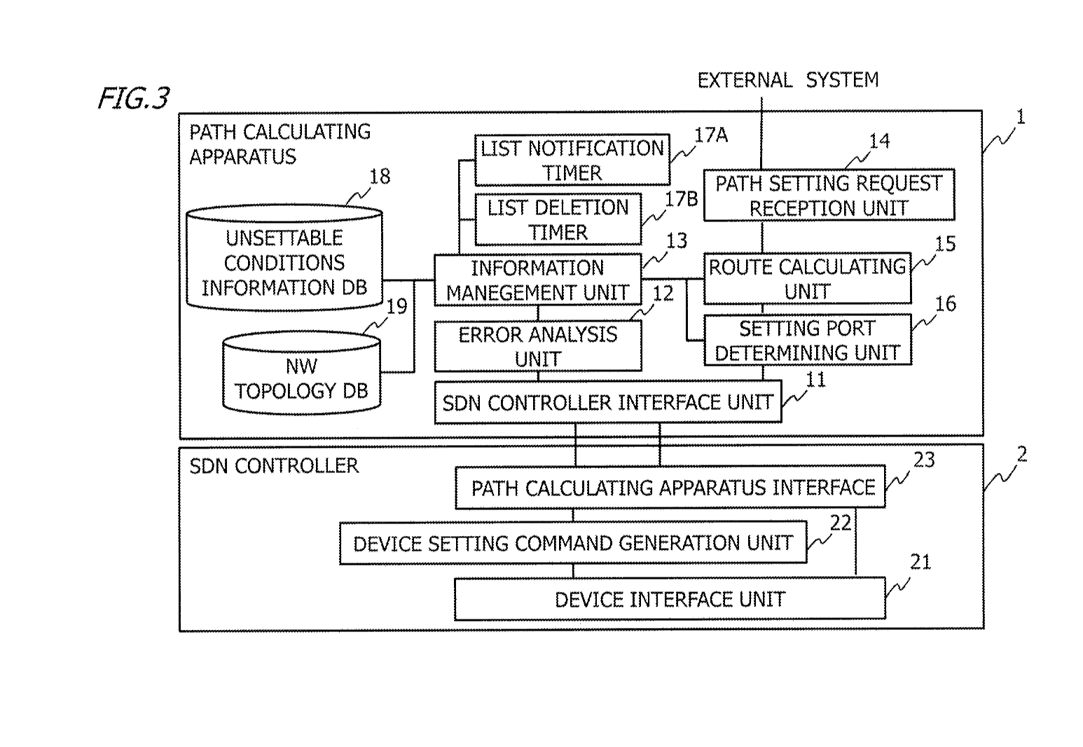

FIG. 3 is a diagram illustrating an example of the functional configuration of the path calculating apparatus 1 and the SDN controller 2. The path calculating apparatus 1 includes, as functional components, an SDN controller interface unit 11, an error analysis unit 12, an information management unit 13, a path setting request reception unit 14, a route calculating unit 15, a setting port determining unit 16, a list notification timer 17A, a list deletion timer 17B, an unsettable conditions information database (DB) 18, and a network (NW) topology DB 19. The functional configuration of the path calculating apparatus 1 illustrated in FIG. 3 is a functional configuration that is achieved by execution of the path calculation software 105P by the CPU 101.

The path setting request reception unit 14 accepts the input of an optical path setting request from an external system. The optical path setting request includes, for example, identification information of the NEs 3 at both ends of the optical path, and the signal type. The path setting request reception unit 14 outputs the optical path setting request to the route calculating unit 15.

When the optical path setting request is input from the path setting request reception unit 14, the route calculating unit 15 calculates a route between the NEs 3 that are specified by the optical path setting request. The route calculating unit 15 refers to information that is stored in the NW topology DB 19 through the information management unit 13, and calculates a route of the optical path. In a case where that are a plurality of routes between the NEs 3 specified by the optical path setting request, the route calculating unit 15, for example, selects with priority a route on which the number of devices or number of links to go through is smallest (shortest path algorithm). However, a method for calculating a route is not limited to a specific calculation method, and may be any calculation method. The route calculating unit 15 outputs the calculated route to the setting port determining unit 16.

When the route of the optical path is input from the route calculating unit 15, the setting port determining unit 16 refers to information that is stored in the unsettable conditions information DB 18 and the NW topology DB 19 and determines settings contents for each NE 3 on the route. The settings contents for each NE 3 on the route that the setting port determining unit 16 determines are, for example, a port at which to set the optical path and a wavelength. The setting port determining unit 16 outputs a device setting request for an optical path that includes settings contents for each NE 3 on the route of the optical path, to the SDN controller interface unit 11. In addition to the port at which to set the optical path and the wavelength, the settings contents included in the device setting request for an optical path also includes the signal type that is specified in the optical path setting request.

The SDN controller interface unit 11 is an interface with the SDN controller 2. Upon receiving the input of the device setting request for an optical path from the setting port determining unit 16, the SDN controller interface unit 11 transmits the device setting request for an optical path to the SDN controller 2. The SDN controller interface unit 11 also receives from the SDN controller 2 a device setting error message or a device setting OK message with respect to the device setting request for an optical path. The SDN controller interface unit 11 outputs the device setting error message with respect to the device setting request for an optical path to the error analysis unit 12 and the setting port determining unit 16.

The SDN controller interface unit 11 also receives a notification of a change in the device configuration information of the NEs 3 from the SDN controller 2. The notification of a change in the device configuration information of the NEs 3 includes, for example, information relating to reinstallation of hardware of an NE 3, a change in a connection relation between links, replacement of a module that includes a port, a change in a wavelength assignment with respect to a port, and a change in the configuration of an NE 3, such as release of a port. The SDN controller interface unit 11 outputs the notification of a change in the device configuration information of the NEs 3 to the information management unit 13. The notification of a change in the device configuration information of the NEs 3 is one example of a “notification of a configuration change” of an “optical transmission device”.

Upon a device setting error message with respect to the device setting request for an optical path being input from the SDN controller interface unit 11, the error analysis unit 12 analyzes the device setting error message. In the first embodiment, since it is assumed that the protocol used for setting an optical path with respect to the NEs 3 is OpenFlow, for example, an error message of OpenFlow corresponds to the device setting error message.

In some cases an error reason is included in the device setting error message from the NE 3, and in some cases an error reason is not included therein. For example, an error reason is not included in the device setting error message in a case where there is a difference between the versions of OpenFlow supported by the SDN controller 2 and the NE 3, or depending on the specifications of the manufacturer of the NE 3.

If an error reason is included in the device setting error message, the error analysis unit 12 outputs the error reason included in the device setting error message to the information management unit 13 as error information. If an error reason is not included in the device setting error message, the error analysis unit 12 outputs a device setting command corresponding to the device setting error message to the information management unit 13 as error information. The device setting error message is one example of a “setting error”.

The information management unit 13 performs management of the unsettable conditions information DB 18 and the NW topology DB 19. When error information of the device setting error message is received from the error analysis unit 12, the information management unit 13 stores the error information of the device setting error message in the unsettable conditions information DB 18. When a notification of a change in the device configuration information of the NEs 3 is received from the SDN controller interface unit 11, the information management unit 13 performs processing with respect to information in the unsettable conditions information DB 18 and the NW topology DB 19 in accordance with the received notification of a change in the device configuration information.

Further, in response to a request from the route calculating unit 15, the information management unit 13 reads out information that is stored in the NW topology DB 19 and outputs the information to the route calculating unit 15. In response to a request from the setting port determining unit 16, the information management unit 13 reads out information that is stored in the unsettable conditions information DB 18 and the NW topology DB 19 and outputs the information to the setting port determining unit 16

The information management unit 13 also performs management of the unsettable conditions information DB 18 using the list notification timer 17A and the list deletion timer 17B. The list notification timer 17A is a timer that controls a timing at which to notify information in the unsettable conditions information DB 18 to a user of the host system. The information management unit 13 reads out information in the unsettable conditions information DB 18 and notifies the user of the host system of the information when the list notification timer 17A becomes 0.

The list deletion timer 17B is a timer for managing the term of validity of information in the unsettable conditions information DB 18. When the list deletion timer 17B becomes 0, the information management unit 13 deletes information in the unsettable conditions information DB 18.

The unsettable conditions information DB 18 stores error information included in device setting error messages that are transmitted from the NEs 3. The unsettable conditions information DB 18 is created in a storage area of the main memory 102 of the path calculating apparatus 1 that executes the path calculation software 105P. For example, an optical cross-connect unsettable ports list, an unsettable wavelengths list, an unsettable signal types list and an unsettable contents list are stored in the unsettable conditions information DB 18. Each of these lists is described in detail later. The information stored in the unsettable conditions information DB 18 is one example of a “setting condition”.

The NW topology DB 19 stores information relating to the topology of the optical transport network 50. The NW topology DB 19 is created in a storage area of the main memory 102 of the path calculating apparatus 1 that executes the path calculation software 105P. For example, a NE possession ports list, a paths list, an optical cross-connects list, a links list and an entire ports list are stored in the NW topology DB 19.

The SDN controller 2 includes, as functional components, a device interface unit 21, a device setting command generation unit 22, and a path calculating apparatus interface unit 23. The functional configuration of the SDN controller 2 illustrated in FIG. 3 is a functional configuration that is achieved by execution of the SDN controller program by the CPU 101.

The path calculating apparatus interface unit 23 is an interface of the path calculating apparatus 1. The path calculating apparatus interface unit 23 receives a device setting request for an optical path from the path calculating apparatus 1. The path calculating apparatus interface unit 23 outputs the device setting request for an optical path that is received to the device setting command generation unit 22.

Further, the path calculating apparatus interface unit 23 accepts the input of a device setting error message or a settings OK message with respect to a device setting command, information for updating the configuration of the optical transport network 50, or information for updating a device configuration from the device interface unit 21. The path calculating apparatus interface unit 23 transmits the device setting error message or settings OK message with respect to a device setting command, the information for updating the configuration of the optical transport network 50, or the information for updating a device configuration to the path calculating apparatus 1.

When a device setting request is input from the path calculating apparatus interface unit 23, the device setting command generation unit 22 generates a device setting command for setting the contents of a device setting request with respect to the NEs 3. According to the first embodiment, since it is assumed that OpenFlow is the protocol used for setting an optical path with respect to the NEs 3, for example, a FlowMod message of OpenFlow corresponds to the device setting command. The device setting command generation unit 22 outputs the generated device setting command to the device interface unit 21. The device setting command is one example of “settings information including settings contents with respect to an optical transmission device”.

The device interface unit 21 is an interface with the NEs 3. The device interface unit 21 receives the input of a device setting command from the device setting command generation unit 22. The device interface unit 21 transmits the inputted device setting command to the NEs 3. The device interface unit 21 receives a device setting error message or a settings OK message with respect to a device setting command, information for updating the configuration of the optical transport network 50, or information for updating a device configuration from the NEs 3. The device interface unit 21 outputs the received device setting error message or settings OK message with respect to a device setting command, or notification of a change in the device configuration information of an NE 3 to the path calculating apparatus interface unit 23.

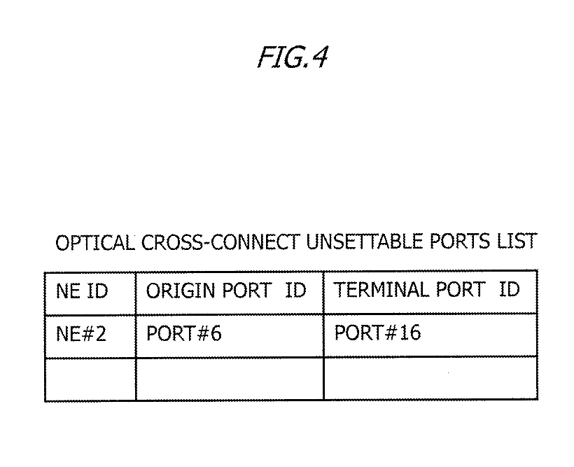

FIG. 4 to FIG. 7 illustrate examples of lists that are stored in the unsettable conditions information DB 18. FIG. 4 illustrates an example of the optical cross-connect unsettable ports list. The optical cross-connect unsettable ports list is stored in the unsettable conditions information DB 18. The term “optical cross-connect” refers to technology for transmitting an optical signal from one optical fiber to a different optical fiber, and in the first embodiment refers to switching of optical signals inside the respective NEs 3. Accordingly, in the first embodiment, an optical cross-connect is defined by two ports inside the same NE 3. The optical cross-connect unsettable ports list stores information regarding combinations of two ports for which it is not possible to set an optical cross-connect of respective NEs 3 that is learned from device setting error messages from the NEs 3.

Items for an NE ID, an origin port ID and a terminal port ID are included in a single entry of the optical cross-connect unsettable ports list illustrated in FIG. 4. An origin port and a terminal port are a combination of two ports for which it is not possible to set an optical cross-connect. The NE ID is identification information of an NE 3, and for example is a name that is assigned to the NE 3. The port ID is, for example, a number assigned to a port. In the first embodiment it is assumed that optical cross-connects are distinguished depending on the direction, so that, for example, an optical cross-connect from port #1 to port #2 and an optical cross-connect from port #2 to port #1 are identified as different optical cross-connects. However, because optical cross-connects also exist that support bidirectional transmission, the present invention is not limited to the above configuration in a case where an optical cross-connect supports bidirectional transmission.

An entry of the optical cross-connect unsettable ports list is created in a case where an error reason is included in a device setting error message that is received and the error reason is that it is not possible to set an optical cross-connect. The combination of ports for which it is not possible to set an optical cross-connect is included in the device setting error message.

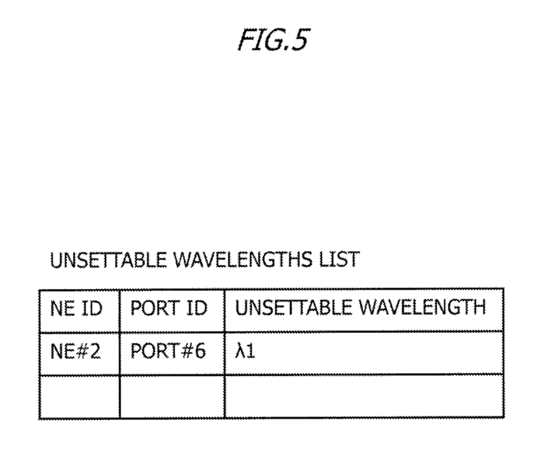

FIG. 5 illustrates an example of the unsettable wavelengths list. The unsettable wavelengths list is stored in the unsettable conditions information DB 18. The unsettable wavelengths list stores information regarding wavelengths which it is not possible to set at ports of the NEs 3 that is learned from device setting error messages from the NEs 3.

Items for an NE ID, a port ID and an unsettable wavelength are included in a single entry of the unsettable wavelengths list illustrated in FIG. 5. The value of a wavelength that it is not possible to set at the relevant port is stored in the item for the unsettable wavelength of the entry in the unsettable wavelengths list.

An entry of the unsettable wavelengths list is created in a case where an error reason is included in a device setting error message that is received, and the error reason is that it is not possible to set a wavelength. The information regarding a port and an unsettable wavelength that is stored in an entry of the unsettable wavelengths list is acquired from the device setting error message.

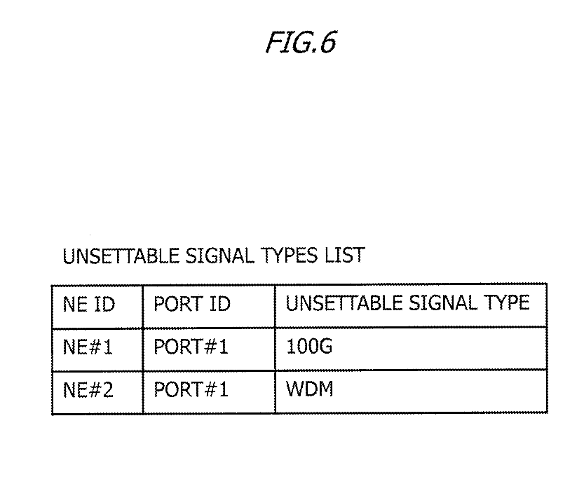

FIG. 6 illustrates an example of the unsettable signal types list. The unsettable signal types list is stored in the unsettable conditions information DB 18. The unsettable signal types list stores information regarding signal types that it is not possible to set at ports of the NEs 3 that is learned from device setting error messages from the NEs 3.

Items for an NE ID, a port ID, and an unsettable signal type are included in a single entry of the unsettable signal types list illustrated in FIG. 6. A signal type that it is not possible to set at the relevant port is stored in the item for the unsettable signal type. A value that is stored as the unsettable signal type is, for example, any one of 10G, 100G and WDM. The values 10G and 100G indicate the output speed of an optical signal at a port on an OCH side. A port on the OCH side is a port that transmits a single wavelength signal that is obtained by separating a signal received from a WDM-side port into the respective wavelengths thereof, or that receives a single wavelength signal. The term “WDM” indicates that the relevant port is a port on the WDM side. A port on the OCH side is an example of a “first port”.

An entry in the unsettable signal types list is created in a case where an error reason is included in a received device setting error message and the error reason is that it is not possible to set a signal type. The information for a port and a signal type that it is not possible to set that is included in an entry of the unsettable signal types list is acquired from a device setting error message.

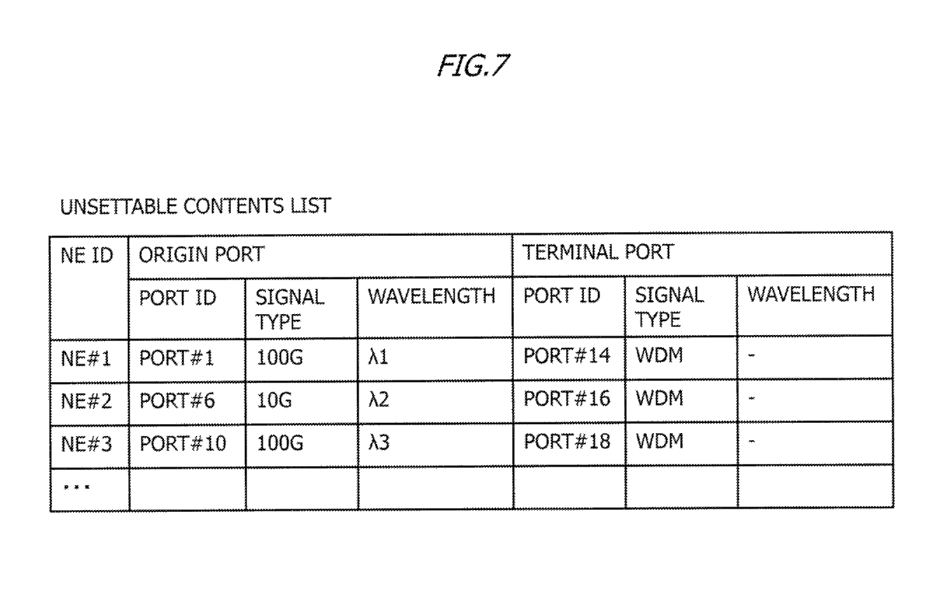

FIG. 7 illustrates an example of the unsettable contents list. The unsettable contents list is stored in the unsettable conditions information DB 18. The unsettable contents list stores information regarding settings contents of device setting commands which resulted in errors at the NEs 3 that is learned from device setting error messages from the NEs 3.

In a single entry of the unsettable contents list illustrated in FIG. 7, items for a port ID, a signal type and a wavelength are included with respect to each of an NE ID, an origin port and a terminal port. The origin port and the terminal port are a combination of ports of an optical cross-connect of the settings contents which resulted in an error. A signal type and a value of a wavelength that were specified with respect to each of the origin port and the terminal port that are included in the settings contents that resulted in the error are stored in the items for signal type and wavelength.

An entry is created in the unsettable contents list in a case where an error reason is not included in a device setting error message that is received. The information that is stored in an entry of the unsettable contents list is acquired from the settings contents of a device setting command (device setting request) corresponding to the device setting error message.

The data structures of the optical cross-connect unsettable ports list, unsettable wavelengths list, unsettable signal types list and unsettable contents list that are illustrated in FIG. 4 to FIG. 7 are examples, and these data structures can be appropriately changed in accordance with the embodiment. Further, in addition to the optical cross-connect unsettable ports list, the unsettable wavelengths list, the unsettable signal types list and the unsettable contents list, lists having other information that is acquirable from device setting error messages may also be stored in the unsettable conditions information DB 18. Hereinafter, the term “unsettable conditions lists” is used when collectively referring to the optical cross-connect unsettable ports list, the unsettable wavelengths list, the unsettable signal types list and the unsettable contents list that are stored in the unsettable conditions information DB 18.

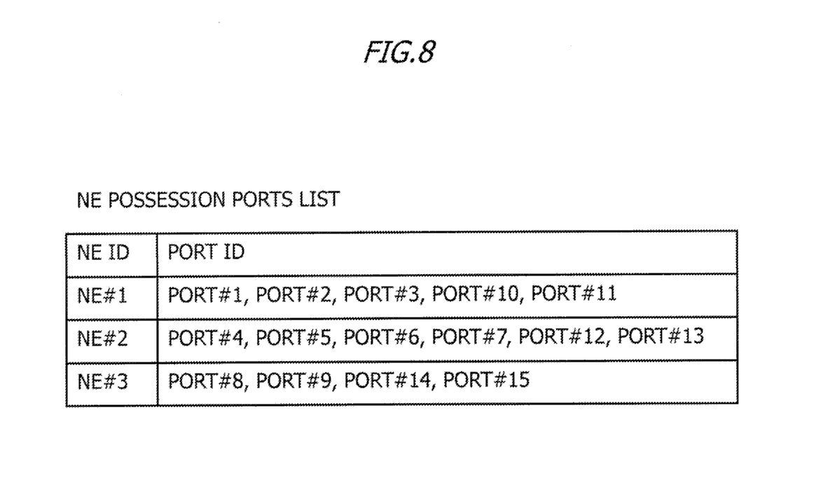

FIG. 8 to FIG. 12 illustrate examples of lists that are stored in the NW topology DB 19. FIG. 8 illustrates an example of the list of ports internally held by NEs. The NE possession ports list is stored in the NW topology DB 19. The NE possession ports list stores information regarding ports held by each NE 3 in the optical transport network 50.

Items for an NE ID and port IDs are included in a single entry in the NE possession ports list illustrated in FIG. 8. Identification information for all ports the corresponding NE 3 is equipped with is included in the item for port IDs in the entry of the NE possession ports list.

The information in the entries in the NE possession ports list is registered in advance by an administrator of the optical transport network system 100. In a case where a notification of a change in the device configuration information of an NE 3 is received and the content of the notification indicates that there is a change in the hardware configuration of the NE 3 or a change in a module including a port of the NE 3, information in a relevant entry of the NE possession ports list is updated by the information management unit 13 in accordance with the content of the notification.

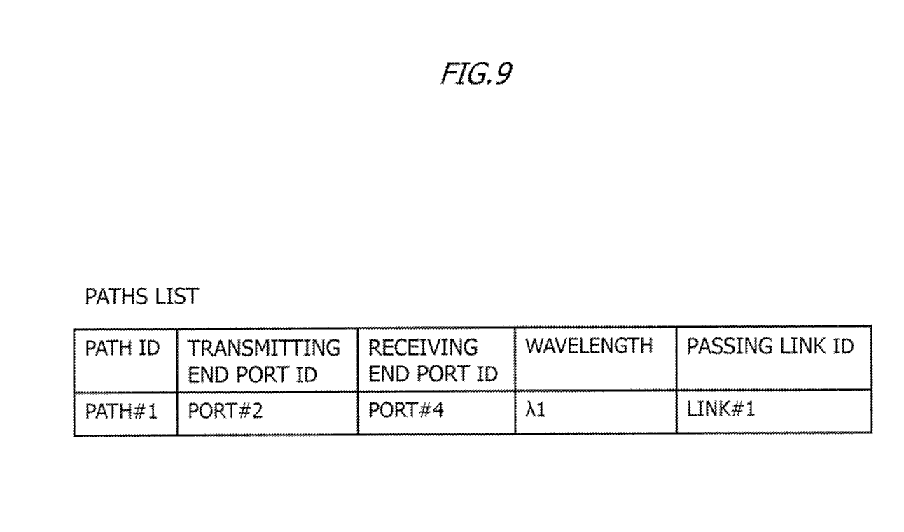

FIG. 9 illustrates an example of the paths list. The paths list is stored in the NW topology DB 19. The paths list stores information regarding optical paths that are established within the optical transport network 50.

Items for a path ID, a transmitting end port ID, a receiving end port ID, a wavelength and a passing link ID are included in a single entry in the paths list illustrated in FIG. 9. The port IDs for the ports of the NEs 3 on the transmitting side and the receiving side are stored in the items for transmitting end port ID and receiving end port ID, respectively, of the entry in the paths list. In a case where a port is uniquely identified by a combination of the NE ID and the port ID, the NE ID of the NE 3 and the port ID of the respective ports on the transmitting side and the receiving side are stored in the items for transmitting end port ID and receiving end port ID, respectively, of the entry in the paths list.

The value of the wavelength for the relevant optical path is stored in the item for wavelength in the entry in the paths list. The link ID of a link that the relevant optical path goes through is stored in the item for passing link ID in the entry in the paths list. If an optical path goes through a plurality of links, the link IDs of each of the plurality of links that the relevant optical path goes through are stored in the item for passing link ID in the entry in the paths list.

The paths list is empty in an initial state. An entry in the paths list is generated by the information management unit 13 in a case where an optical path is established, for example, when a device setting OK message is received from the NEs 3. Further, in a case where a notification of a change in the device configuration information of an NE 3 is received and the content of the notification indicates that a port is released or the like, the information of a corresponding entry in the paths list is updated by the information management unit 13 in accordance with the content of the notification. The release of a port means that an optical path is eliminated.

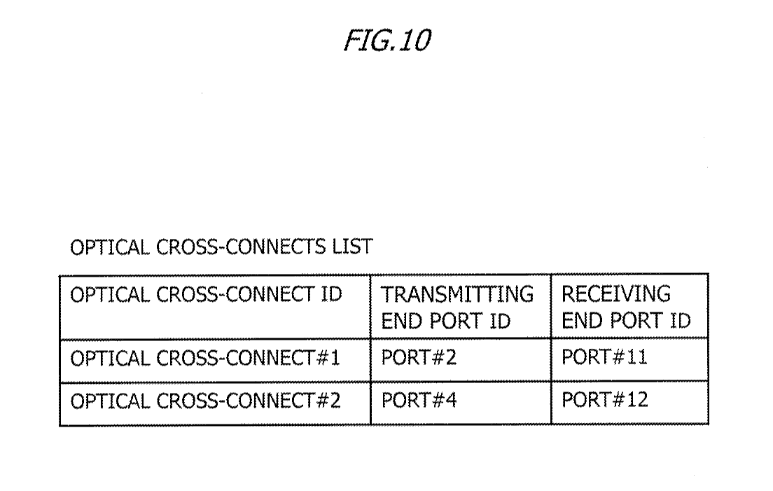

FIG. 10 illustrates an example of the optical cross-connects list. The optical cross-connects list is stored in the NW topology DB 19. The optical cross-connects list stores information regarding optical cross-connects that are established inside each NE 3 within the optical transport network 50.

Items for an optical cross-connect ID, a transmitting end port ID and a receiving end port ID are included in a single entry of the optical cross-connects list illustrated in FIG. 10. The transmitting end port and the receiving end port are ports in the same NE 3.

The optical cross-connects list is empty in an initial state. An entry in the optical cross-connects list is generated by the information management unit 13 in a case where an optical path is established, for example, when a device setting OK message is received from the NEs 3. Further, in a case where a notification of a change in the device configuration information of an NE 3 is received and the content of the notification is to the effect that a port is released or the like, the information of a corresponding entry in the optical cross-connect list is updated by the information management unit 13 in accordance with the content of the notification. The release of a port means that an optical cross-connect is eliminated.

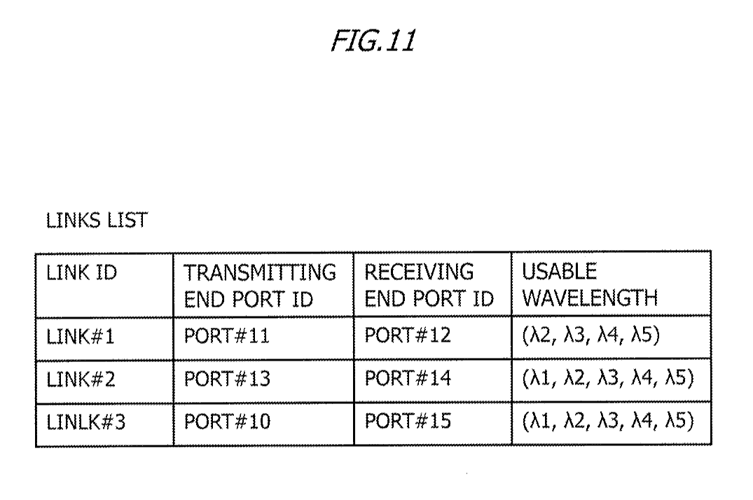

FIG. 11 illustrates an example of the links list. The links list is stored in the NW topology DB 19. The links list stores information regarding links that are established within the optical transport network 50.

Items for a link ID, a transmitting end port ID, a receiving end port ID, and usable wavelengths are included in a single entry of the links list illustrated in FIG. 11. Port IDs of ports of different NEs 3 are stored in the items for transmitting end port ID and receiving end port ID, respectively, in the entry of the links list. The values of all wavelengths that can be used for the relevant link are stored in the item for usable wavelengths in the entry of the links list.

Entries for links in the optical transport network 50 are generated in the links list in an initial state. Further, in a case where an optical path is set, or in a case where a notification of a change in device configuration information is received and the notification contents are to the effect that a port is released or the like, the item for usable wavelengths in the information of a corresponding entry of the links list is updated by the information management unit 13.

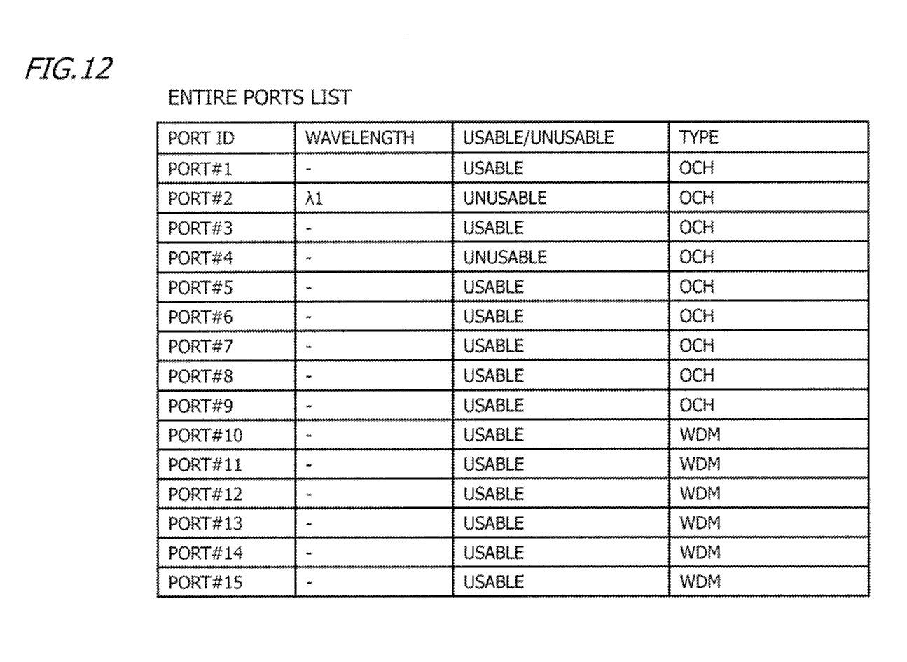

FIG. 12 is an example of the entire ports list. The entire ports list is stored in the NW topology DB 19. The entire ports list stores information regarding all ports that exist in the optical transport network 50.

A single entry of the entire ports list illustrated in FIG. 12 includes items for port ID, wavelength, usable/unusable, and type. The value of a wavelength for an optical path that is set for the relevant port is stored in the item for wavelength of the entry of the entire ports list. “Usable” or “unusable” is stored in the item for usable/unusable of the entry of the entire ports list. The initial value of the item for usable/unusable is “usable”.

Information indicating the type of the relevant port is stored in the item for type of the entry of the entire ports list. In the first embodiment, either OCH or WDM is stored as a value in the item for type of the entry of the entire ports list. The value “OCH” indicates that the port performs a conversion between an optical signal and an electrical signal, and is a port that handles an optical signal of a single wavelength. The value “WDM” indicates that the port multiplexes and transmits optical signals of a plurality of channels. Accordingly, an OCH port is a port that is used to connect with a router or a switch or the like. A WDM port is a port that is used to connect with another NE 3.

Entries of a quantity that correspond to all the ports in the optical transport network system 100 are created in the entire ports list in an initial state. Values are registered in advance by the administrator in the items for port ID and type of the respective entries of the entire ports list. In a case where an optical path is set, or in a case where a notification of a change in the device configuration information of an NE 3 is received and the content of the notification is to the effect that a port is released or the like, the values of the items for wavelength and usable/unusable in the corresponding entry of the entire ports list are updated by the information management unit 13.

The data structures of the NE possession ports list, the paths list, the optical cross-connects list, the links list and the entire ports list illustrated in FIG. 8 to FIG. 12 are examples, and these data structures can be appropriately changed in accordance with the embodiment. Further, in addition to the NE possession ports list, the paths list, the optical cross-connects list, the links list and the entire ports list, lists having other information may also be stored in the NW topology DB 19. Hereinafter, the term “NW topology lists” is used when collectively referring to the NE possession ports list, the paths list, the optical cross-connects list, the links list and the entire ports list that are stored in the NW topology DB 19.

### Flow of Processing

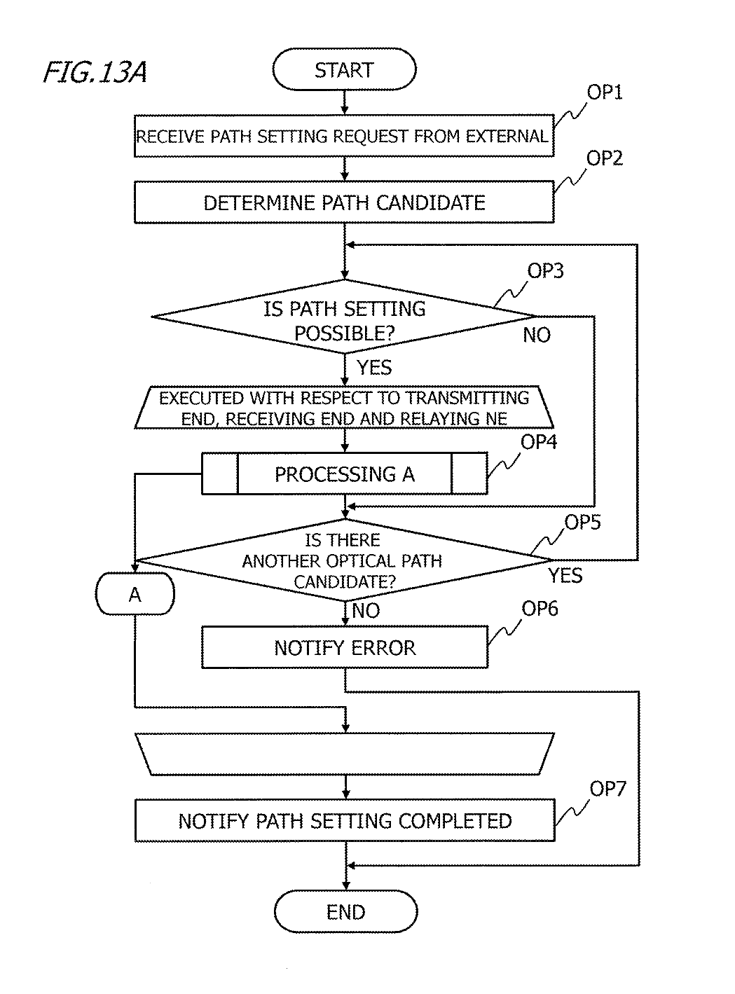

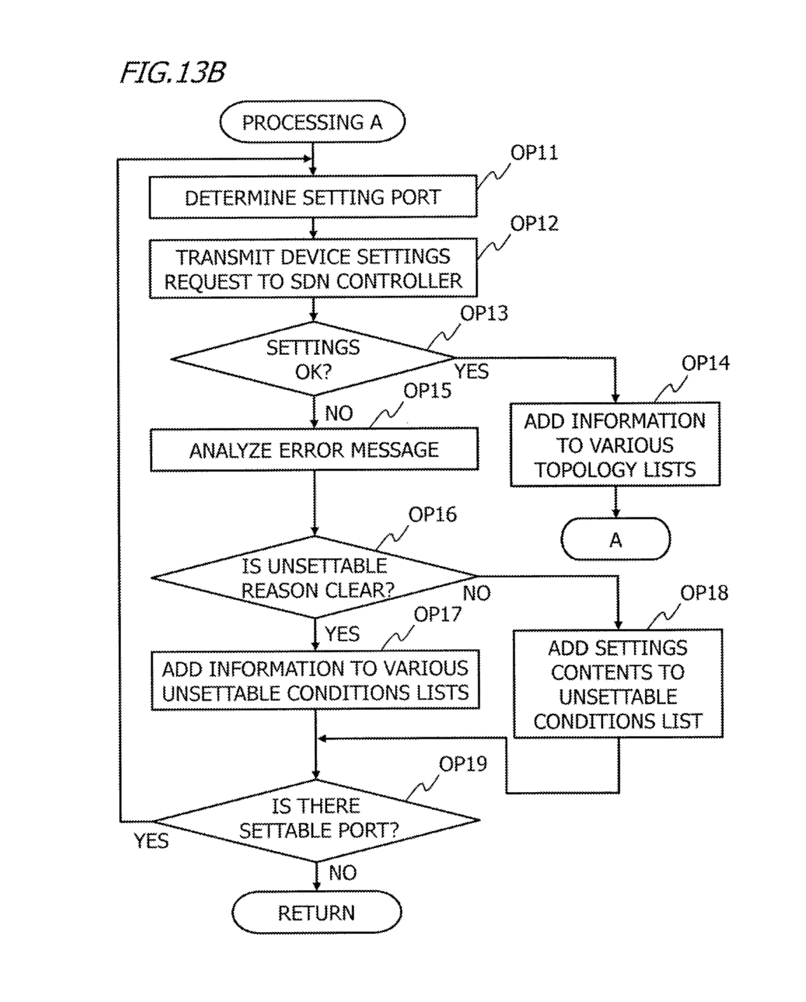

FIG. 13A and FIG. 13B illustrate examples of flowcharts of optical path setting processing of the path calculating apparatus 1. The processing illustrated in FIG. 13A is started when a setting request with respect to an optical path is input from an external system. Although the entity executing the processing illustrated in FIG. 13A and FIG. 13B is the CPU 101 that executes the path calculation software 105P, for convenience, a functional component is described as the entity.

In OP1, the path setting request reception unit 14 receives an optical path setting request from an external system, and outputs the optical path setting request to the route calculating unit 15. For example, the NE IDs of the NEs 3 to serve as the transmitting end and receiving end of the optical path, and the speed (signal type) of the optical path are included in the optical path setting request.

In OP2, the route calculating unit 15 refers to the NW topology lists to calculate a route between the transmitting end and receiving end that are specified by the optical path setting request, and selects a wavelength to set, to thereby determine an optical path candidate. An optical path candidate is defined by a combination of a route and a wavelength. Accordingly, for example, a combination of a route 1 and a wavelength λ1 and a combination of the route 1 and a wavelength λ2 are different optical path candidates. When there are a plurality of optical path candidates, for example, the candidate having the least number of links that the route goes through and the smallest wavelength value is preferentially selected. The route calculating unit 15 outputs the determined optical path candidate to the setting port determining unit 16.

In OP3, the setting port determining unit 16 refers to the unsettable conditions lists to determine whether or not the optical path candidate can be set. For example, in a case where information regarding the ports of NEs 3 on the route of the optical path candidate is not stored in any of the unsettable conditions lists, and the wavelength of the optical path candidate is usable at the links of the route of the optical path candidate, the setting port determining unit 16 determines that the optical path can be set on the selected route.

Further, for example, in a case where a combination of ports for which an optical cross-connect can be set does not exist at any of the NEs 3 on the route of the optical path candidate, the setting port determining unit 16 determines that it is not possible to set the selected optical path. A case where a combination of ports for which an optical cross-connect can be set does not exist is, for example, a case where an optical cross-connect is already set at each port, or a case where all combinations of ports are registered in the unsettable ports list or the unsettable contents list. In addition, even when there is a port that is not registered in the unsettable ports list or the unsettable contents list, in some cases an optical cross-connect is already set at the relevant port. Further, for example, with respect to any NE 3 on the route, in a case where “unsettable” is not registered for a signal type specified by the optical path setting request in the unsettable signal types list or the unsettable contents list and there is no port that is not being used, it is determined that it is not possible to set the optical path on the selected route. Further, with respect to each NE 3 on the route, even in a case where a port exists at which an optical cross-connect can be set and a signal type that is specified by the optical path setting request can be set, if the wavelength of the optical path candidate is registered as an unsettable wavelength for the relevant port in the unsettable wavelengths list, it is determined that it is not possible to set the optical path on the selected route.

If it is determined that the selected optical path candidate can be set (OP3: YES), the processing proceeds to OP4. If it is determined that it is not possible to set the selected optical path candidate (OP3: NO), the processing proceeds to OP5.

In OP4, processing to determine a setting port for the optical path and to transmit a setting command with respect to the optical path is performed for each NE 3 on the route of the selected optical path candidate. Details of the processing to determine a setting port for the optical path and to transmit a setting command with respect to the optical path for each NE 3 will be described later. In the processing in OP4, if it is not possible to set the optical path for the selected optical path candidate, the processing proceeds to OP5. In the processing in OP4, if setting of a target NE 3 is completed and a next NE 3 exists on the route, the processing proceeds to OP4, while if a next NE 3 does not exist on the route, setting of the optical path is completed and the processing proceeds to OP7.

In OP5, the setting port determining unit 16 determines whether or not there is another optical path candidate. If there is another optical path candidate (OP5: YES), the processing proceeds to OP3, and the processing from OP3 onward is performed for the other optical path candidate. If there is no other optical path candidate (OP5: NO), the processing proceeds to OP6.

In OP6, since it is not possible to set the optical path that is the object of the optical path setting request, the setting port determining unit 16 outputs an error to the external system. Thereafter, the processing illustrated in FIG. 13A ends.

In OP7, since the optical path that is the object of the optical path setting request could be set, the setting port determining unit 16 outputs a notification to the effect that setting of the path is completed to the external system. Thereafter, the processing illustrated in FIG. 13A ends.

FIG. 13B illustrates an example of processing to determine a setting port for an optical path and to transmit a setting command with respect to the optical path that is executed for each NE 3 on the route of the selected optical path candidate. The processing in FIG. 13B is started in a case where, in the processing in OP3 in FIG. 13A, it is determined that the optical path can be set with respect to the selected optical path candidate.

In OP11, the setting port determining unit 16 refers to the unsettable conditions lists and the NE possession ports list to select, for the target NE 3, a combination of ports for setting an optical path, that is, a combination of ports for setting an optical cross-connect, with respect to the route of the optical path candidate.

In OP12, the setting port determining unit 16 transmits a device setting request including the combination of ports of the optical cross-connect, a signal type and a wavelength and the like to be set for the target NE 3 to the SDN controller 2 through the SDN controller interface unit 11. Thereafter, the SDN controller 2 generates a device setting command in accordance with the settings contents included in the device setting request, and transmits the device setting command to the target NE 3.

In OP13, the setting port determining unit 16 receives a response to the device setting request from the target NE 3, and determines whether the response to the device setting request is the device setting OK message or the device setting error message. If the response to the device setting request is the device setting OK message (OP13: YES), the processing proceeds to OP14. If the response to the device setting request is the device setting error message (OP13: NO), the processing proceeds to OP15.

In OP14, the device setting OK message is input to the setting port determining unit 16, and the setting port determining unit 16 updates the various NW topology lists through the information management unit 13 with respect to the information of the optical path that is newly set. Updating of the NW topology lists in OP14 consists of, for example, addition of information regarding the optical cross-connect at the target NE 3 that is newly set to the optical cross-connects list, and updating of a usable wavelength of a link involving the target NE 3 that is newly set to the links list. Further, for example, the updating of the NW topology lists consists of updating of an entry for a setting port of the target NE 3 in the entire ports list. Furthermore, for example, in a case where the target NE 3 is the NE 3 at the transmitting end and is the final NE 3 on the route, information of the optical path that is newly set is added to the paths list.

After the processing in OP14, if there is an NE 3 that has not yet been set on the route, the processing from OP11 (OP4 in FIG. 13A) is performed for the next NE 3. If there is not an NE 3 that has not yet been set on the route, the processing of FIG. 13B ends, and the processing proceeds to OP7 in FIG. 13A.

In OP15, since the response to the device setting request of the target NE 3 is the device setting error message, the device setting error message is input to the error analysis unit 12, and the error analysis unit 12 analyzes the device setting error message.

In OP16, the error analysis unit 12 determines whether or not the reason that setting is not possible that is included in the device setting error message is clear. Whether or not the reason that setting is not possible included in the device setting error message is clear is determined based on whether or not the reason that setting is not possible is included in the device setting error message and whether or not the device setting error message can be analyzed. If the reason that setting is not possible that is included in the device setting error message is clear (OP16: YES), the processing proceeds to OP17. If the reason that setting is not possible that is included in the device setting error message is unclear, (OP16: NO), the processing proceeds to OP18.

In OP17, since the reason that setting is not possible is clear, the error analysis unit 12 adds the reason that setting is not possible to various unsettable conditions lists through the information management unit 13. The unsettable conditions list updated in OP17 is any of the optical cross-connect unsettable ports list, the unsettable wavelengths list and the unsettable signal types list.

In OP18, since the reason that setting is not possible is unclear, the error analysis unit 12 adds the contents of the device setting request to the unsettable contents list through the information management unit 13.

In OP19, the setting error is input to the setting port determining unit 16 from the SDN controller interface unit 11, and the setting port determining unit 16 determines whether or not there is another combination of ports with which an optical cross-connect can be set at the target NE 3. If there is another combination of ports with which an optical cross-connect can be set at the target NE 3 (OP19: YES), the processing from OP11 is executed with respect to the other combination of ports. If there is not another combination of ports with which an optical cross-connect can be set at the target NE 3 (OP19: NO), the processing proceeds to OP5 in FIG. 13A.

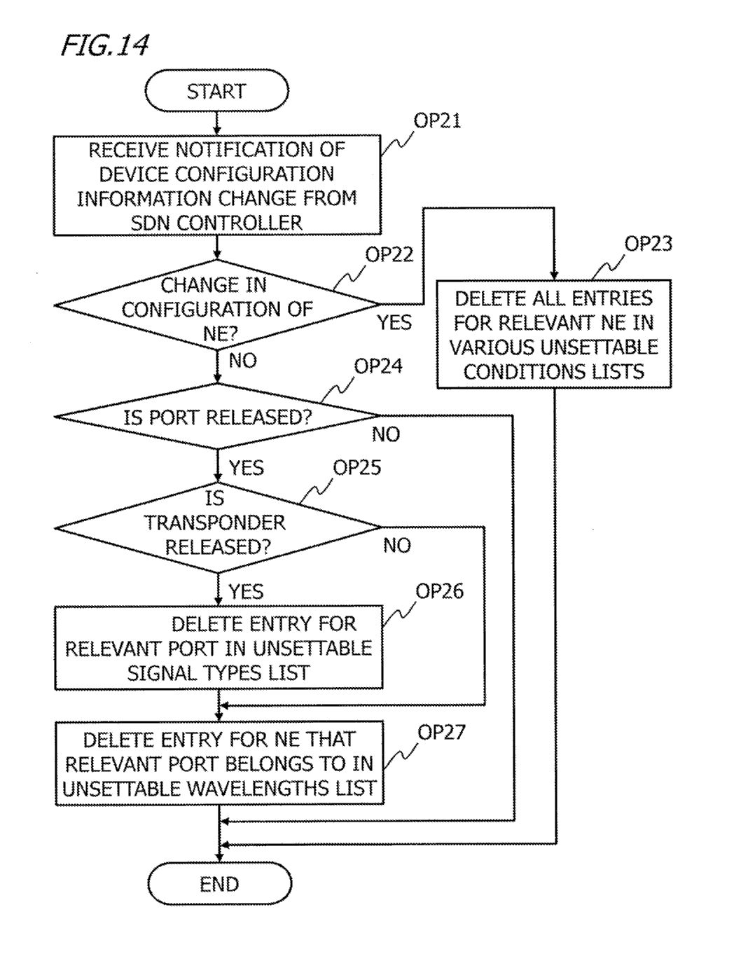

FIG. 14 illustrates an example of a flowchart of processing to update the unsettable conditions lists of the path calculating apparatus 1. The processing illustrated in FIG. 14 is started in a case where the path calculating apparatus 1 receives a notification of a change in the device configuration information from the SDN controller 2. Although the entity executing the processing illustrated in FIG. 14 is the CPU 101 that executes the path calculation software 105P, for convenience, a functional component is described as the entity.

In OP21, the SDN controller interface unit 11 receives a notification of a change in the device configuration information from the SDN controller 2, and outputs the notification of a change in the device configuration information to the information management unit 13.

In OP22, the information management unit 13 determines whether or not the content of the notification of a change in the device configuration information is that there is a change in the configuration of the NE 3. A change in the configuration of the NE 3 refers to, for example, a change to a CD-ROADM (Colorless Directionless ROADM) from a classic ROADM (Reconfigurable Optical Add/Drop Multiplexer) that is described later, or the addition of a route or the like. If the content of the notification of a change in the device configuration information is that there is a change in the configuration of the NE 3 (OP22: YES), the processing proceeds to OP23. If the content of the notification of a change in the device configuration information is not that there is a change in the configuration of the NE 3 (OP22: NO), the processing proceeds to OP24.

In OP23, since the content of the notification of a change in the device configuration information is that there is a change in the configuration of the NE 3, the information management unit 13 deletes all entries in the various unsettable conditions lists that correspond to the NE 3. Thereafter the processing illustrated in FIG. 14 ends.

In OP24, the information management unit 13 determines whether or not the content of the notification of a change in the device configuration information is that a port is released. If the content of the notification of a change in the device configuration information is that a port is released (OP24: YES), the processing proceeds to OP25. If the content of the notification of a change in the device configuration information is not that a port is released (OP24: NO), the processing illustrated in FIG. 14 ends.

In OP25, the information management unit 13 determines whether or not a change in a transponder is notified together with the release of a port in the notification of a change in the device configuration information. A transponder is a device that performs conversion between an electrical signal and an optical signal, and a port that is connected to a transponder is a port on the OCH side. If a change in a transponder has been notified together with the release of a port (OP25: YES), the processing proceeds to OP26. If notification of solely the release of a port has been notified (OP25: NO), the processing proceeds to OP27.

In OP26, the information management unit 13 deletes an entry in the unsettable signal types list that corresponds to the released port. This is because the released port is connected to the changed transponder, and there is a possibility that an unsettable signal type of the relevant port may change as the result of a change in the transponder.

In OP27, the information management unit 13 deletes an entry in the unsettable wavelengths list that corresponds to the NE 3 to which the released port belongs. This is because, for example, if the NE 3 to which the released port belongs is a CD-ROADM, a wavelength that had been set for the released port can be set for another port, and a change thus arises with respect to the unsettable wavelengths for the ports belonging to the NE 3. Further, this is also because in a case where a change in a transponder is notified together with the release of a port, there is a possibility that the unsettable wavelengths of the relevant port may also change as a result of the change in the transponder. Thereafter, the processing illustrated in FIG. 14 ends.

The flowcharts illustrated in FIG. 13A, FIG. 13B and FIG. 14 represent examples, and processing of the path calculating apparatus 1 is not limited to the processing in these flowcharts. For example, the order of executing parts of each processing included in the flowcharts illustrated in FIG. 13A, FIG. 13B and FIG. 14 may be appropriately changed in accordance with the embodiment.

### Specific Example

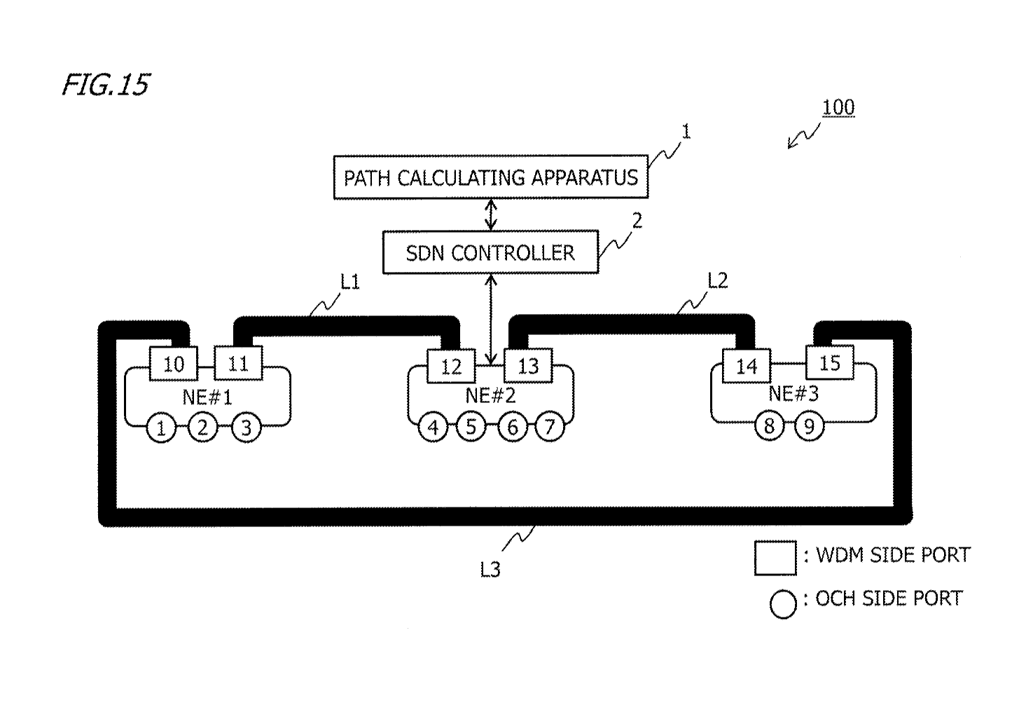

FIG. 15 is a diagram illustrating the topology of the optical transport network system 100 in a specific example. The optical transport network system 100 of the specific example includes an NE #1, an NE #2, and an NE #3. The NE #1 includes a port #1, a port #2, a port #3, a port #10 and a port #11. The NE #2 includes a port #4, a port #5, a port #6, a port #7, a port #12 and a port #13. The NE #3 includes a port #8, a port #9, a port #14 and a port #15. The ports #1 to #9 are OCH-side ports. The ports #10 to #15 are WDN-side ports.

The NE #1 and the NE #2 are connected by a link L1 between port #11 and port #12. The NE #2 and the NE #3 are connected by a link L2 between port #13 and port #14. The NE #3 and the NE #1 are connected by a link L3 between port #15 and port #10.

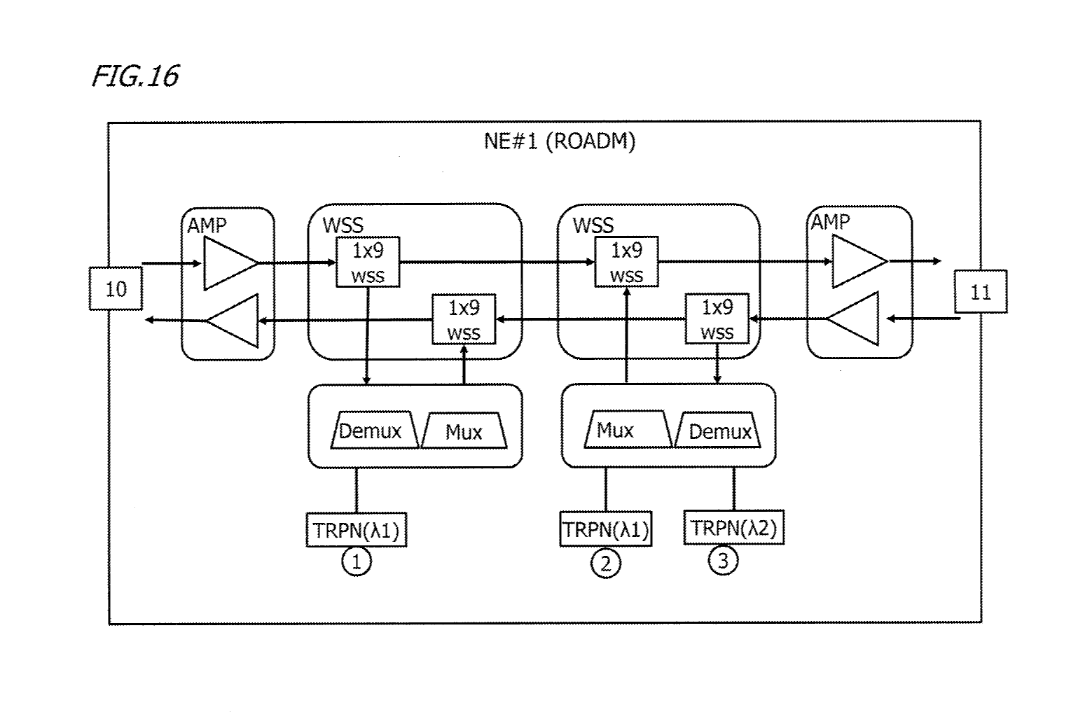

FIG. 16 is a diagram illustrating an example of the hardware configuration of the NE #1 in the specific example. The NE #1 is an optical wavelength multiplexing device that is called a “classic ROADM”. In a classic ROADM, a predetermined single WDM port is designated in advance as a WDM port to which an optical cross-connect can be connected from respective OCH ports, and a predetermined single wavelength is also designated in advance as a wavelength that an OCH port can use.

In the NE #1, there is a constraint that it is not possible to set an optical cross-connect between port #1 and port #11, between port #2 and port #10, and between port #3 and port #10. Further, in the NE #1, there is a constraint that it is not possible to set wavelengths other than designated wavelengths λ1, λ1, and λ2 for port #1, port #2, and port #3, respectively.

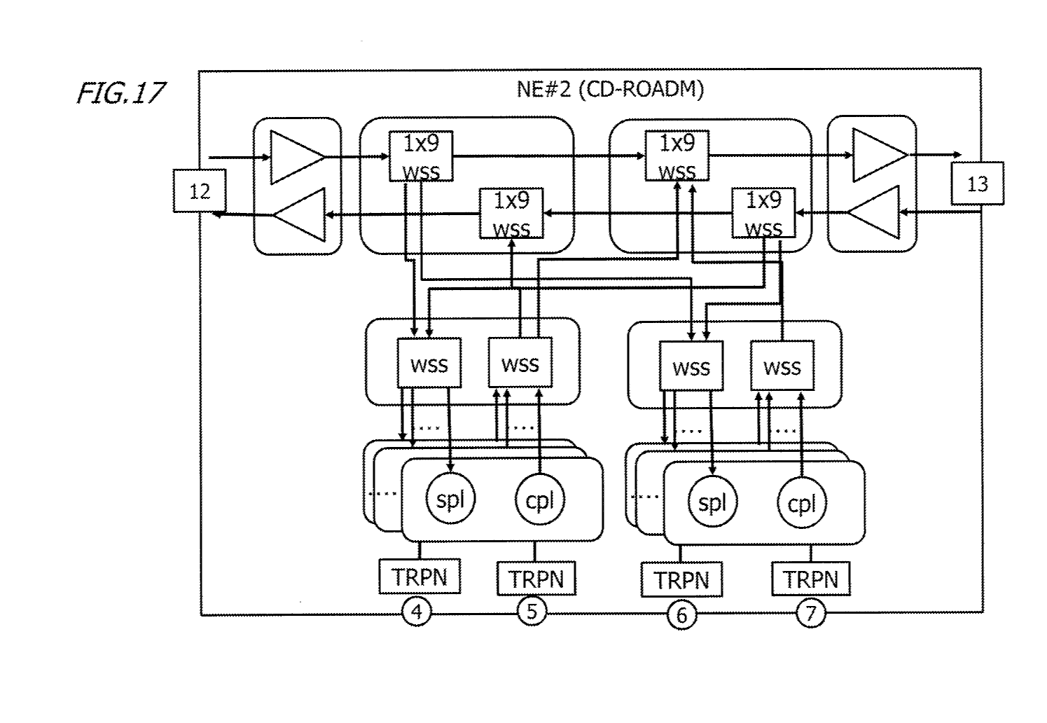

FIG. 17 is a diagram illustrating an example of the hardware configuration of the NE #2 in the specific example. The NE #2 is an optical wavelength multiplexing device that is called a “CD-RODAM” in which the constraints of the classic ROADM regarding an WDM port that an optical cross-connect can be connected to an OCH port and regarding wavelengths that OCH ports can use do not exist. The CD-ROADM is a device in which an optical cross-connect can be set to an arbitrary WDM port with an arbitrary wavelength that are selected by an administrator.

However, in the CD-RODAM there is a constraint that it is not possible to set the same wavelength at ports that belong to the same module. In the NE #2 illustrated in FIG. 17, port #4 and port #5 belong to the same module and it is not possible to set the same wavelength at port #4 and port #5. Further, port #6 and port #7 belong to the same module and it is not possible to set the same wavelength at port #6 and port #7.

In the specific example, it is assumed that the optical transport network system 100 is in an initial state. That is, it is assumed that the path calculating apparatus 1 is in a state in which device configuration constraints are not recognized for any of the NEs 3.

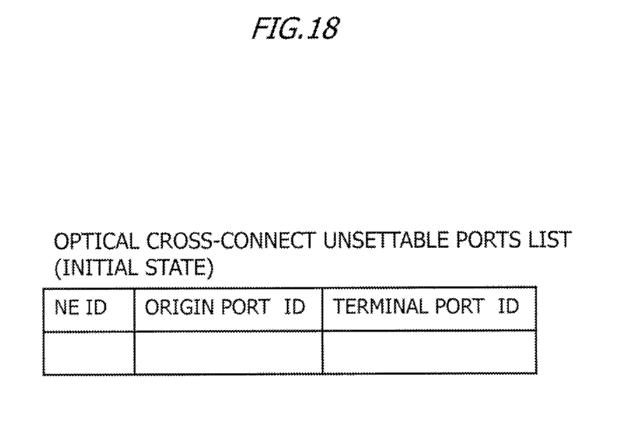

FIG. 18 illustrates an example of the optical cross-connect unsettable ports list in an initial state. The initial state of the optical cross-connect unsettable ports list is an empty state.

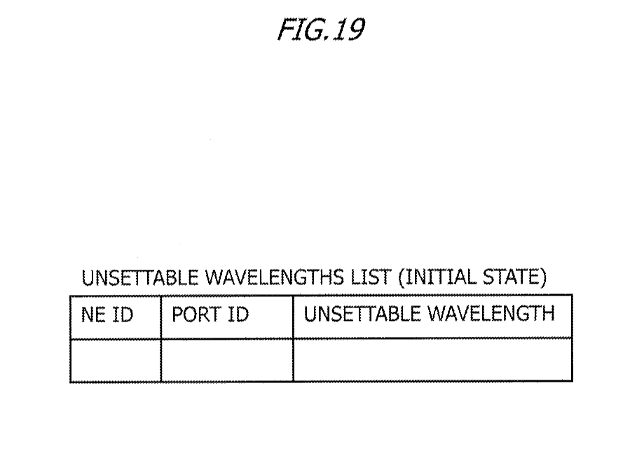

FIG. 19 illustrates an example of the unsettable wavelengths list in an initial state. The initial state of the unsettable wavelengths list is an empty state.

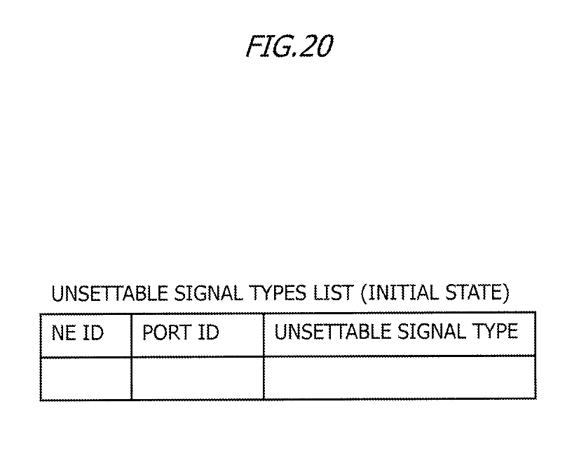

FIG. 20 illustrates an example of the unsettable signal types list in an initial state. The initial state of the unsettable signal types list is an empty state.

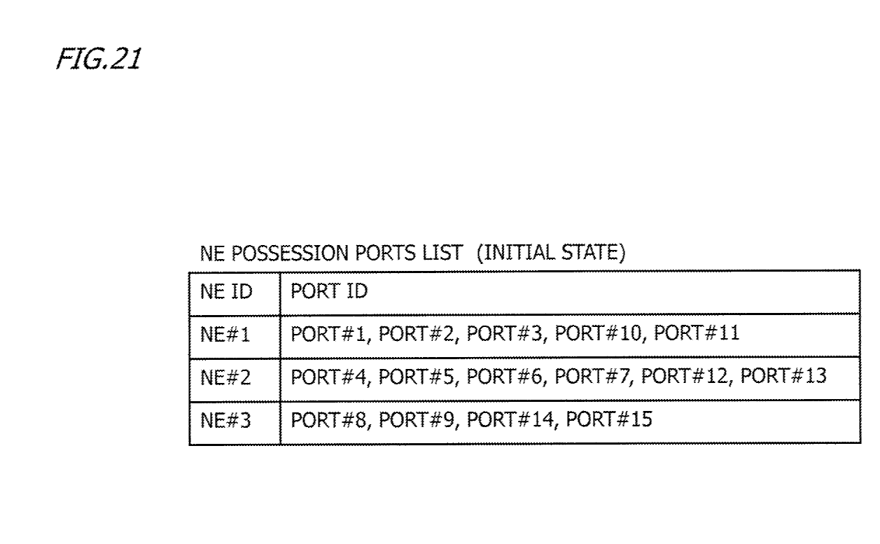

FIG. 21 illustrates an example of the NE possession ports list in an initial state. In the initial state, the port IDs of ports that each NE 3 holds are registered in the NE possession ports list.

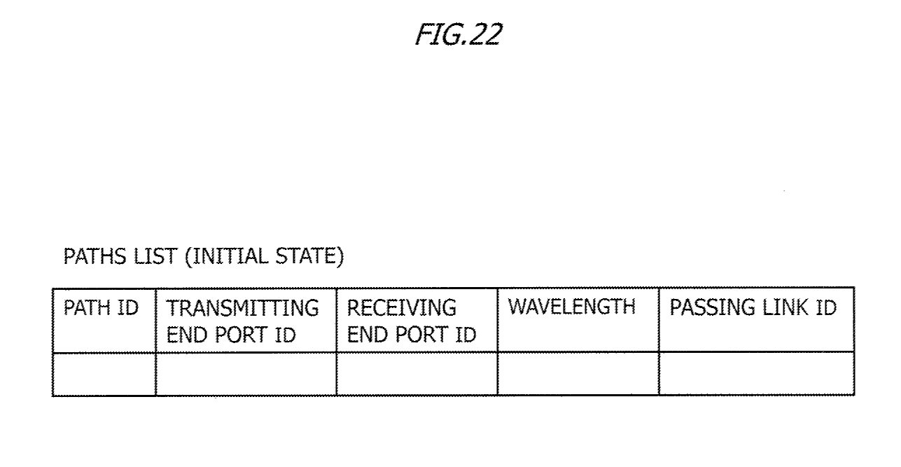

FIG. 22 illustrates an example of the paths list in an initial state. The initial state of the paths list is an empty state.

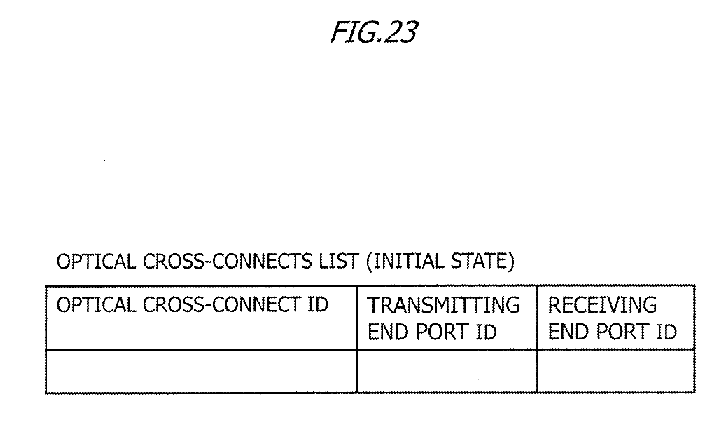

FIG. 23 illustrates an example of the optical cross-connects list in an initial state. The initial state of the optical cross-connects list is an empty state.

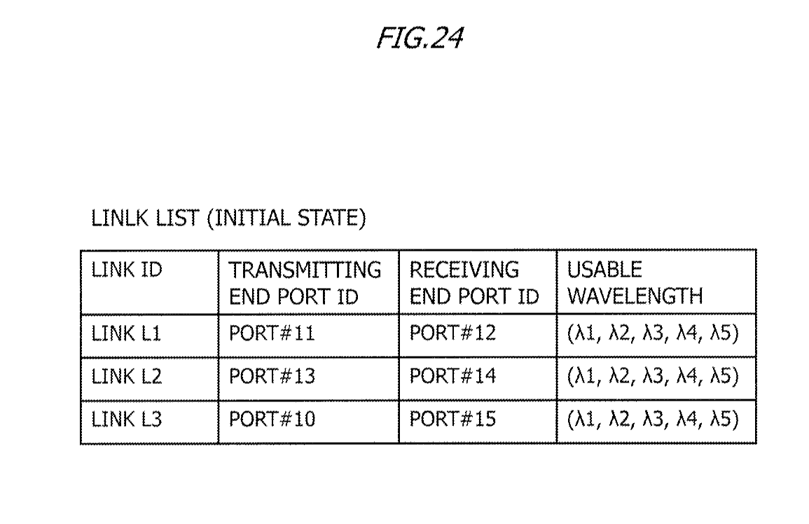

FIG. 24 illustrates an example of the links list in an initial state. In the initial state, information regarding links that exist in the optical cross-connect network 50 are stored in the links list. In the example illustrated in FIG. 24, entries for the link L1, the link L2 and the link L3 are stored.

In the specific example, it is assumed that the number of wavelengths that can be set for each NE 3 is five. Further, in the specific example, since it is assumed that the optical transport network system 100 is in an initial state, the path calculating apparatus 1 does not know the wavelengths that can be set for the links of the respective NE 3. Therefore, five wavelengths λ1 to λ5 that can be set for each NE 3 are stored as initial values in the item for usable wavelengths of each entry of the links list illustrated in FIG. 24.

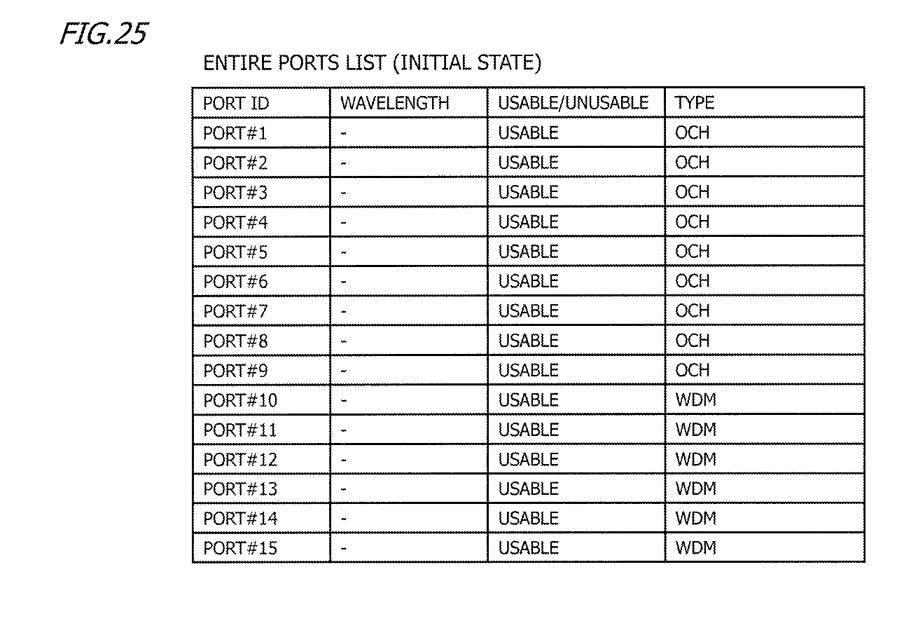

FIG. 25 illustrates an example of the entire ports list in an initial state. In the initial state, an entry for each port in the optical transport network system 100 is created in the entire ports list. The initial value of the wavelength item of each entry is blank. The initial value of the item for “usable/unusable” of each entry is “usable”. In the item for “type” of each entry, a value indicating the type of each port is stored.

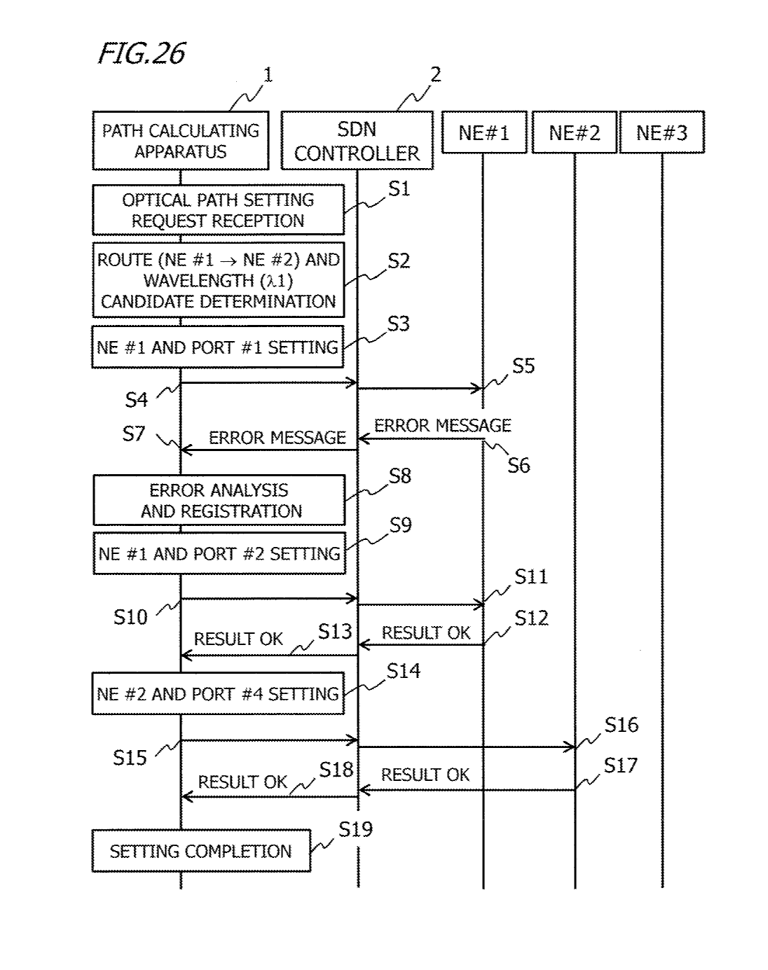

FIG. 26 is a diagram illustrating an example of a processing sequence in a case of setting an optical path between the NE #1 and the NE #2 in the initial state of the optical transport network system 100 of the specific example. For the example illustrated in FIG. 26, the optical transport network system 100 is as illustrated in FIG. 15. Further, the various unsettable conditions lists and NW topology lists are as illustrated in FIG. 18 to FIG. 25. Note that, in FIG. 26, for simplicity, an optical path and an optical cross-connect are considered with regard to a single direction. Further, for simplicity, in the specific example the unsettable contents list is omitted because it is assumed that a reason that setting is not possible is included in a setting error message transmitted from each NE 3 and that the setting error message can be analyzed by the path calculating apparatus 1.

In S1, the path calculating apparatus 1 receives an optical path setting request from an external system (not illustrated) (FIG. 13A, OP1). It is assumed that the optical path setting request that is received in S1 is a request to set a 100G optical path between the NE #1 and the NE #2.

In S2, the path calculating apparatus 1 determines a candidate for the optical path between the NE #1 and the NE #2 (FIG. 13A, OP2). With regard to the route of the optical path between the NE #1 and the NE #2, the path calculating apparatus 1 refers to the NE possession ports list (FIG. 21) and the links list (FIG. 24), and calculates a route that goes through the link L1 and a route that goes through the link L3 and the link L2. The path calculating apparatus 1 also refers to the links list (FIG. 24) and determines that all of the wavelengths λ1 to λ5 are usable. In S2, as the optical path candidate, the path calculating apparatus 1 selects the route that goes through the link L1 that is the shortest route and the wavelength λ1. Note that, as another optical path candidate, for example, an optical path candidate that includes the route that goes though the link L1 and the wavelength λ2 also exists.

With regard to the optical path that goes through the link L1 and for which the wavelength is the wavelength λ1, an entry corresponding to port #11 and port #12 on the link L1 does not exist in any of the optical cross-connect unsettable ports list (FIG. 18), the unsettable wavelengths list (FIG. 19) and the unsettable signal types list (FIG. 20). Further, the wavelength λ1 can be used on the link L1. Therefore, the path calculating apparatus 1 determines that the optical path that goes through the link L1 and for which the wavelength is wavelength λ1 can be set (FIG. 13A, OP3: YES).

In S3, the path calculating apparatus 1 selects the NE #1 that is a device on the route as a target device, and selects port #1 as a setting port of the NE #1 (FIG. 13B, OP11). More specifically, the path calculating apparatus 1 refers to the NE possession ports list (FIG. 21) and the unsettable conditions lists (FIG. 18 to FIG. 20), and selects a setting port from among the ports belonging to the NE #1 and for which an entry does not exist in any of the unsettable conditions lists. In S3, since information is not stored in any of the unsettable conditions lists (FIG. 18 to FIG. 20), it is assumed that the path calculating apparatus 1 selects port #1.

In S4, the path calculating apparatus 1 transmits a device setting request to the SDN controller (FIG. 13B, OP12). The settings contents of the device setting request that is transmitted in S4 include, with respect to the NE #1, a setting for an optical cross-connect between port #1 and port #11, and a setting for a signal of the wavelength λ1 and the signal type 100G for port #1.

In S5, the SDN controller 2 generates a device setting command with respect to the device setting request received from the path calculating apparatus 1, and transmits the device setting command to the NE #1.

In S6, at the NE #1, since it is not possible to set an optical cross-connect between port #1 and port #11 (FIG. 16), the device setting command received from the SDN controller 2 results in a setting error. The NE #1 transmits a device setting error message including information to the effect that it is not possible to set an optical cross-connect between port #1 and port #11 as an error reason to the SDN controller 2.

In S7, the SDN controller 2 transmits the device setting error message from the NE #1 to the path calculating apparatus 1.

In S8, the path calculating apparatus 1 receives the device setting error message from the NE #1 (FIG. 13B, OP13: NO), and analyzes the device setting error message (FIG. 13B, OP15). Since information to the effect that it is not possible to set an optical cross-connect between port #1 and port #11 is included as the error reason in the device setting error message (FIG. 13B, OP16: YES), the path calculating apparatus 1 registers the combination of port #1 and port #11 in the optical cross-connect unsettable ports list.

In S9, the path calculating apparatus 1 selects port #2 as the next port that can be set at the NE #1 (FIG. 13B, OP19: YES, OP11). In S9, since the combination of port #1 and port #11 is registered in the optical cross-connect unsettable ports list, and information regarding port #2 is not stored in any of the unsettable conditions lists (FIG. 18 to FIG. 20), port #2 is suitable as a port that can be set.

In S10, the path calculating apparatus 1 transmits a device setting request to the SDN controller (FIG. 13B, OP12). The settings contents of the device setting request that is transmitted in S10 include, with respect to the NE #1, a setting for an optical cross-connect between port #2 and port #11, and a setting for a signal of the wavelength λ1 and the signal type 100G at port #2.

In S11, the SDN controller 2 generates a device setting command with respect to the device setting request received from the path calculating apparatus 1, and transmits the device setting command to the NE #1.

In S12, at the NE #1, since an optical cross-connect can be set between port #2 and port #11 (FIG. 16), and a signal of the wavelength λ1 and the signal type 100G can be set at port #2, the settings in the device setting command received from the SDN controller 2 can be set without an error. The NE #1 transmits a device setting OK message to the SDN controller 2.

In S13, the SDN controller 2 transmits the device setting OK message from the NE #1 to the path calculating apparatus 1.

In S14, the path calculating apparatus 1 receives the device setting OK message from the NE #1 (FIG. 13B, OP13: YES), selects the NE #2 that is the next device on the route as a target device, and designates port #4 as the setting port (FIG. 13B, OP11). In S14, since the combination of port #1 and port #11 is registered in the optical cross-connect unsettable ports list, and information regarding port #4 is not stored in any of the unsettable conditions lists (FIG. 18 to FIG. 20), port #4 is suitable as a port that can be set.

Further, in S14, since a new optical cross-connect is set, the path calculating apparatus 1 registers the combination of port #2 and port #11 in the optical cross-connects list (FIG. 13B, OP14). Further, the path calculating apparatus 1 updates the item for usable/unusable in the entry for port #2 in the entire ports list to “unusable” and updates the item for wavelength to “λ1”.

In S15, the path calculating apparatus 1 transmits a device setting request to the SDN controller (FIG. 13B, OP12). The settings contents of the device setting request that is transmitted in S15 include, with respect to the NE #2, a setting for an optical cross-connect between port #4 and port #12, and a setting for a signal of the wavelength λ1 and the signal type 100G at port #4.

In S16, the SDN controller 2 generates a device setting command with respect to the device setting request received from the path calculating apparatus 1, and transmits the device setting command to the NE #2.

In S17, at the NE #2, since an optical cross-connect can be set between port #4 and port #12 (FIG. 17), and a signal of the wavelength λ1 and the signal type 100G can be set at port #4, the settings in the device setting command received from the SDN controller 2 can be set without an error. The NE #2 transmits a device setting OK message to the SDN controller 2.

In S18, the SDN controller 2 transmits the device setting OK message from the NE #2 to the path calculating apparatus 1.

In S19, the path calculating apparatus 1 receives the device setting OK message from the NE #2 (FIG. 13B, OP13: YES). Since a new optical cross-connect is set, the path calculating apparatus 1 registers the combination of port #4 and port #12 in the optical cross-connects list (FIG. 13B, OP14). Further, since the NE #2 is the terminal device on the route and a new optical path is set, the path calculating apparatus 1 registers an entry for the NE #1, the NE #2, the wavelength λ1 and the passing link L1 in the paths list.

Further, the path calculating apparatus 1 updates the item for usable/unusable in the entry for port #4 in the entire ports list to “unusable” and updates the item for wavelength to “λ1”. The path calculating apparatus 1 also updates the item for usable wavelengths in the entry for the link L1 in the links list by deleting λ1 therefrom. Thereafter, the path calculating apparatus 1 notifies the external system to the effect that setting is completed (FIG. 13A, OP7).

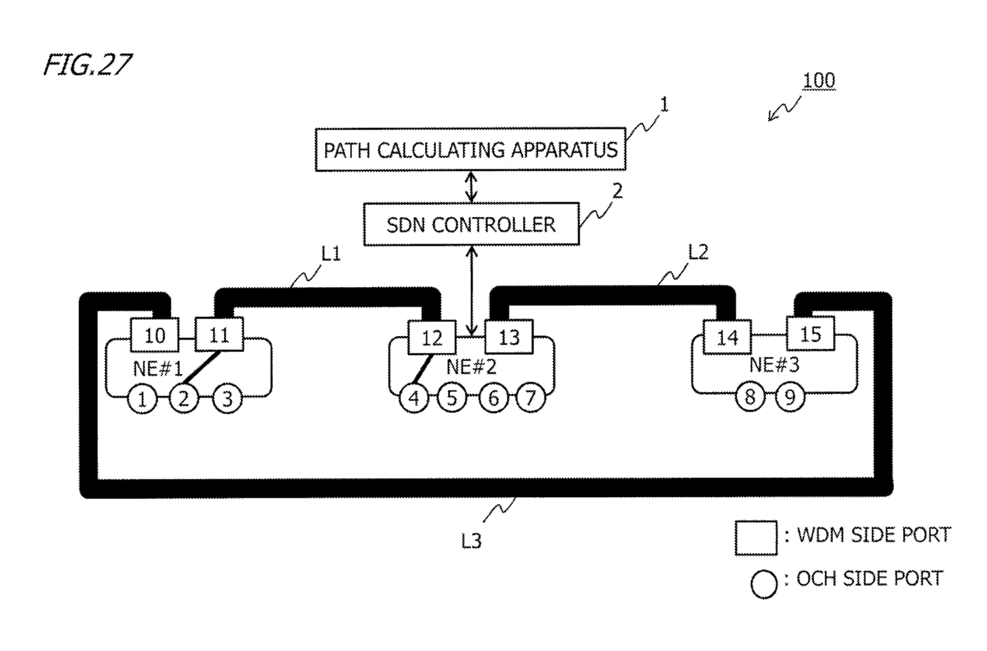

FIG. 27 is a diagram illustrating the optical transport network system 100 of the specific example after setting of the optical path between the NE #1 and the NE #2 in FIG. 26 is completed. In the optical transport network system 100 illustrated in FIG. 27, an optical cross-connect is newly set between port #2 and port #11 in the NE #1, and between port #4 and port #12 in the NE #2.

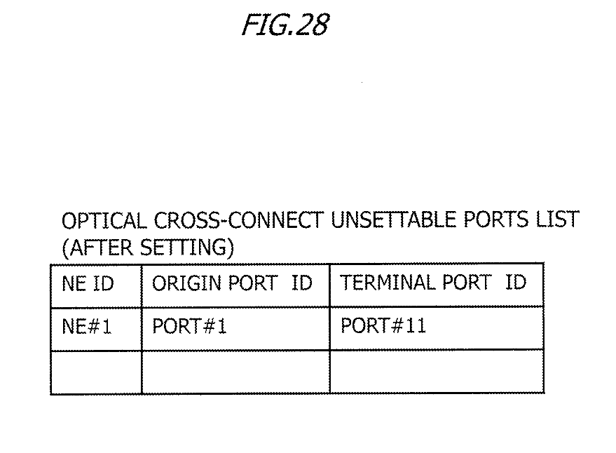

FIG. 28 illustrates an example of the optical cross-connect unsettable ports list after setting of the optical path between the NE #1 and the NE #2 illustrated in FIG. 26 is completed. In the optical cross-connect unsettable ports list, since a combination for which optical cross-connect setting is not possible is registered in S8 in FIG. 26, the combination of port #1 and port #11 is registered in the optical cross-connect unsettable ports list illustrated in FIG. 28.

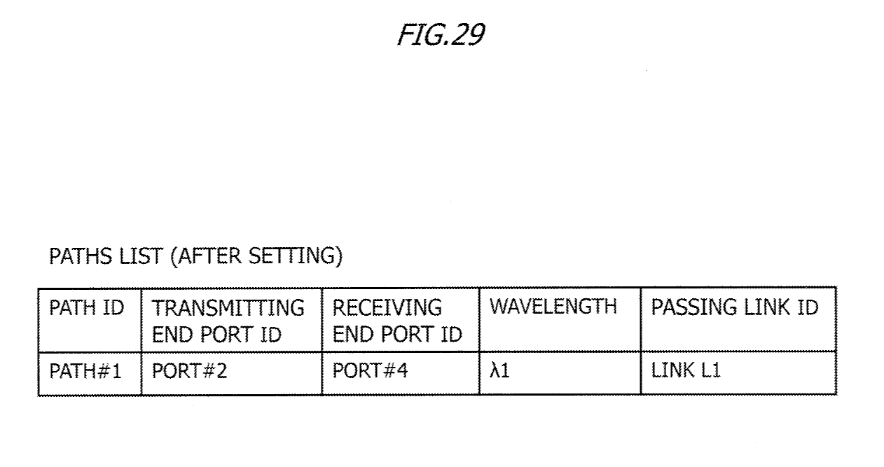

FIG. 29 illustrates an example of the paths list after setting of the optical path between the NE #1 and the NE #2 illustrated in FIG. 26 is completed. In the paths list, since information regarding an optical path that is newly set is registered in S33 in FIG. 26, information regarding the optical path that is newly set between the NE #1 and the NE #2 is registered as path #1 in the paths list illustrated in FIG. 29.

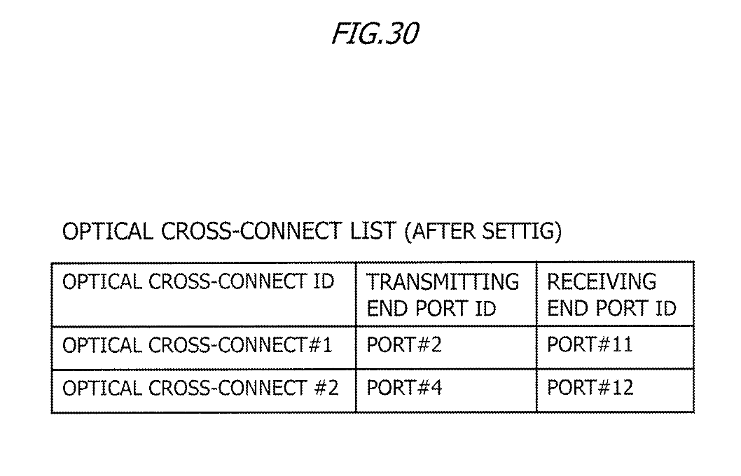

FIG. 30 illustrates an example of the optical cross-connects list after setting of the optical path between the NE #1 and the NE #2 illustrated in FIG. 26 is completed. In the optical cross-connects list, since information regarding optical cross-connects that are newly set is registered in S14 and S19 in FIG. 26, the combination of port #2 and port #11 (registered in S14 in FIG. 26) and the combination of port #4 and port #12 (registered in S19 in FIG. 26) are registered in the optical cross-connects list illustrated in FIG. 30.

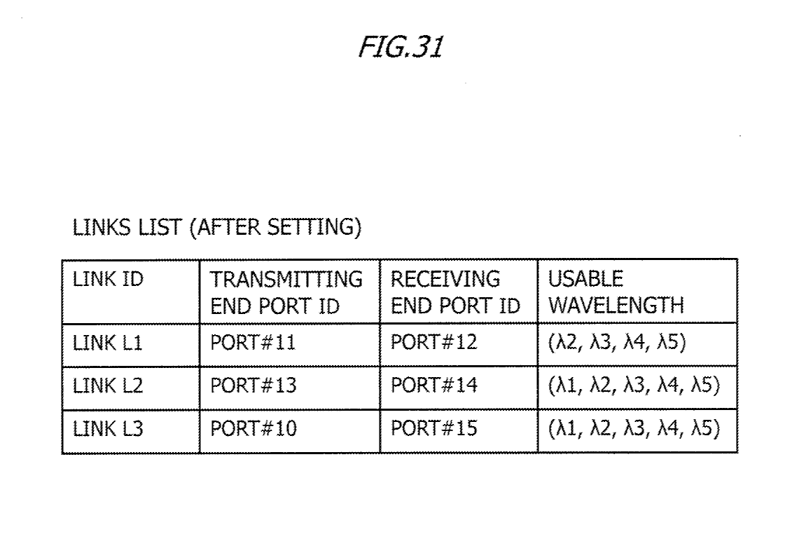

FIG. 31 illustrates an example of the links list after setting of the optical path between the NE #1 and the NE #2 illustrated in FIG. 26 is completed. In a case where setting of the optical path between the NE #1 and the NE #2 is completed in S19 in FIG. 26, the links list is updated by deleting the wavelength λ1 that is used for the optical path from the item for usable wavelengths in the entry for the link L1 that is used for the optical path. Accordingly, λ2 to λ5 are stored in the item for usable wavelengths for the link L1 in the links list illustrated in FIG. 31.

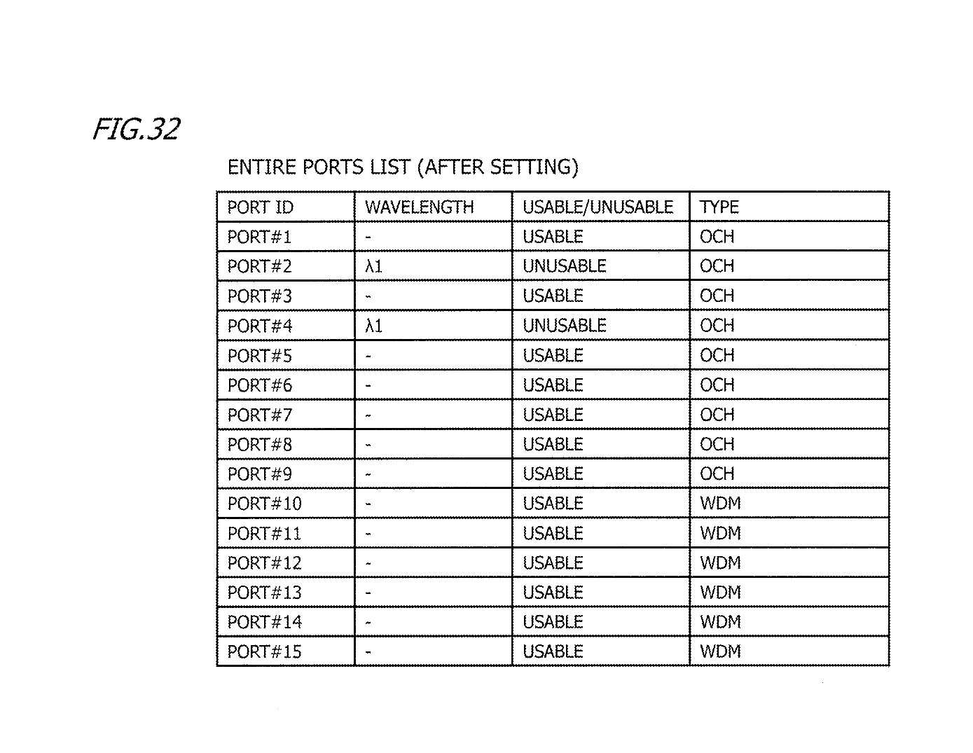

FIG. 32 illustrates an example of the entire ports list after setting of the optical path between the NE #1 and the NE #2 in FIG. 26 is completed. The entire ports list is updated in the case where an optical cross-connect is newly set in S14 and S19 in FIG. 26.

For example, since an optical cross-connect is set between port #2 and port #11 in S14 in FIG. 26, the entire ports list is updated by storing “λ1” in the item for wavelength and storing “unusable” in the item for usable/unusable in the entry for port #2 in the entire ports list. Since port #11 is a WDM port, even if an optical cross-connect is set between port #11 and port #2, it is possible to set an optical path for an optical signal of a different wavelength at port #11, and therefore the entry for port #11 is not updated and the item for usable/unusable remains set to “usable”.

For example, since an optical cross-connect is set between port #4 and port #12 in S19 in FIG. 26, the entire ports list is updated by storing “λ1” in the item for wavelength and storing “unusable” in the item for usable/unusable in the entry for port #4 in the entire ports list. Since port #12 is a WDM port, the entry for port #12 is not updated and the item for usable/unusable remains set to “usable”

Note that because there is no change from the initial state in the unsettable wavelengths list, unsettable signal types list and NE possession ports list, a description regarding the states of these lists after setting of the optical path between the NE #1 and the NE #2 in FIG. 26 is completed is omitted here.

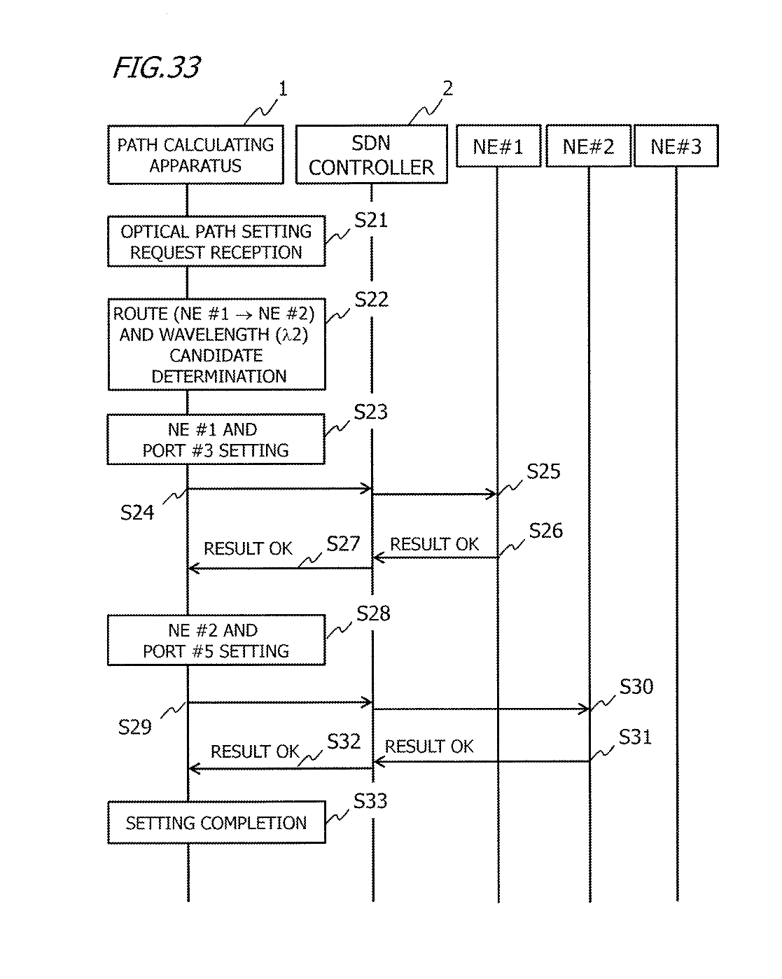

FIG. 33 is a diagram illustrating an example of a processing sequence in a case of setting an optical path between the NE #1 and the NE #2 once again after setting the optical path between the NE #1 and the NE #2 illustrated in FIG. 26 in the optical transport network system 100 of the specific example. The various unsettable conditions lists and NW topology lists are as illustrated in FIG. 28 to FIG. 32. Note that, in FIG. 33, for simplicity, an optical path and an optical cross-connect are considered with regard to a single direction.

In S21, the path calculating apparatus 1 receives an optical path setting request from an external system (not illustrated) (FIG. 13A, OP1). It is assumed that the optical path setting request that is received in S21 is a request to set a 100G optical path between the NE #1 and the NE #2.

In S22, the path calculating apparatus 1 determines a candidate for the optical path between the NE #1 and the NE #2 (FIG. 13A, OP2). With regard to the route of the optical path between the NE #1 and the NE #2, the path calculating apparatus 1 refers to the NE possession ports list (FIG. 21) and the links list (FIG. 31), and calculates a route that goes through the link L1 and a route that goes through the link L3 and the link L2. The path calculating apparatus 1 also refers to the links list (FIG. 31) and determines that, for the link L1, the wavelengths λ2 to λ5 are usable. In S22, as the optical path candidate, the path calculating apparatus 1 selects the route that goes through the link L1 that is the shortest route and the wavelength λ2.

In the optical cross-connect unsettable ports list (FIG. 28), the combination of port #1 and port #11 on the link L1 is registered. However, when the entire ports list and the NE possession ports list are referred to it is found that port #3 on the OCH side can be connected with port #11, and hence it is determined that it is possible to set port #3 for the NE #1. With respect to the NE #2, since there is no information corresponding to any ports thereof in the unsettable conditions lists, it is determined that it is possible to set any of the ports. Accordingly, it is determined that it is possible to set an optical path that goes through the link L1 and uses the wavelength λ2 (FIG. 13A, OP3: YES).

In S23, the path calculating apparatus 1 selects the NE #1 that is a device on the route as a target device, and selects port #3 as the setting port at the NE #1 (FIG. 13B, OP11). More specifically, the path calculating apparatus 1 refers to the NE possession ports list (FIG. 21) and the unsettable conditions list (FIG. 28), and selects a setting port from among the ports belonging to the NE #1 and for which an entry does not exist in any of the unsettable conditions lists. In S23, since information is not stored in any of the unsettable conditions lists (FIG. 28), port #3 is selected.

In S24, the path calculating apparatus 1 transmits a device setting request to the SDN controller (FIG. 13B, OP12). The settings contents of the device setting request that is transmitted in S24 include, with respect to the NE #1, a setting for an optical cross-connect between port #3 and port #11, and a setting for a signal of the wavelength λ2 and the signal type 100G at port #3.

In S25, the SDN controller 2 generates a device setting command with respect to the device setting request received from the path calculating apparatus 1, and transmits the device setting command to the NE #1.

In S26, at the NE #1, since an optical cross-connect can be set between port #3 and port #11 (FIG. 16), and a signal of the wavelength λ2 and the signal type 100G can be set at port #3, the settings in the device setting command received from the SDN controller 2 can be set without an error. The NE #1 transmits the device setting OK message to the SDN controller 2.

In S27, the SDN controller 2 transmits the device setting OK message from the NE #1 to the path calculating apparatus 1.

In S28, the path calculating apparatus 1 receives the device setting OK message from the NE #1 (FIG. 13B, OP13: YES), selects the NE #2 that is the next device on the route as a target device, and designates port #5 as the setting port (FIG. 13B, OP11). In S28, since port #5 is a port of the NE #2 that is usable based on the entire ports list and the NE possession port list, and information regarding port #5 is not stored in any of the unsettable conditions lists (FIG. 28), port #5 is suitable as a port that can be set.

Further, in S28, since a new optical cross-connect is set, the path calculating apparatus 1 registers the combination of port #3 and port #11 in the optical cross-connects list (FIG. 13B, OP14). Further, the path calculating apparatus 1 updates the item for usable/unusable in the entry for port #3 in the entire ports list to “unusable” and updates the item for wavelength to “λ2”.

In S29, the path calculating apparatus 1 transmits a device setting request to the SDN controller (FIG. 13B, OP12). The settings contents of the device setting request that is transmitted in S29 include, with respect to the NE #2, a setting for an optical cross-connect between port #5 and port #12, and a setting for a signal of the wavelength λ2 and the signal type 100G at port #5.

In S30, the SDN controller 2 generates a device setting command with respect to the device setting request received from the path calculating apparatus 1, and transmits the device setting command to the NE #2.

In S31, at the NE #2, since an optical cross-connect can be set between port #5 and port #12 (FIG. 17), and the wavelength λ2 can be set without duplicating the wavelength λ1 of port #4, the settings in the device setting command received from the SDN controller 2 can be set without an error. The NE #2 transmits the device setting OK message to the SDN controller 2.

In S32, the SDN controller 2 transmits the device setting OK message from the NE #2 to the path calculating apparatus 1.

In S33, the path calculating apparatus 1 receives the device setting OK message from the NE #2 (FIG. 13B, OP13: YES). Since a new optical cross-connect is set, the path calculating apparatus 1 registers the combination of port #5 and port #12 in the optical cross-connects list (FIG. 13B, OP14). Further, since the NE #2 is the terminal device on the route and a new optical path is set, the path calculating apparatus 1 registers an entry with the NE #1, the NE #2, the wavelength λ2 and the passing link L1 in the paths list.

Further, the path calculating apparatus 1 updates the item for usable/unusable in the entry for port #5 in the entire ports list to “unusable” and updates the item for wavelength to “λ2”. The path calculating apparatus 1 also updates the item for usable wavelengths in the entry for the link L1 in the links list by deleting λ2 therefrom. Thereafter, the path calculating apparatus 1 notifies the external system of the effect that setting is completed (FIG. 13A, OP7).

### Operations an Effects of First Embodiment

In the above described specific example, when setting the optical path between the NE #1 and the NE #2 the first time (FIG. 26), a device setting command is transmitted to the NE #1 twice. When setting the optical path between the NE #1 and the NE #2 the second time (FIG. 33), a setting command is transmitted to the NE #1 once, which is one time less than the first time. This is because, when setting the optical path the first time, the path calculating apparatus 1 learns an unsettable condition from the device setting error message from the NE #1, and when subsequently setting the optical path the second time, takes the unsettable condition into account when determining the settings of the optical path.

Although the specific example is described on the assumption of an optical transport network that includes three NEs 3, it is assumed that the number of ports, number of wavelengths and number of routes will be much greater in an actual optical transport network. Therefore, as the cumulative number of times settings are made increases, the reduction in the number of times that device setting commands are transmitted and the number of times that device setting error messages with respect to device setting commands are transmitted and the like will be more marked than in the specific example.

Therefore, according to the first embodiment, the time taken for optical path setting, the processing amount of the path calculating apparatus 1, and the network bandwidth that is needed for transmitting device setting commands to devices and device setting error messages from devices can be reduced.

Further, in the first embodiment, in a case where a notification of a device configuration change is received from an NE 3, the path calculating apparatus 1 updates the unsettable conditions lists in accordance with the contents of the device configuration change. For example, in a case in which the NE 3 is the CD-ROADM illustrated in FIG. 17, a wavelength that a port on the OCH side can use is not fixed to a single wavelength, and fluctuates according to the wavelength settings of other ports belonging to the same module. For example, in FIG. 17, port #4 and port #5 belong to the same module. If it is assumed that the usable wavelengths are the five wavelengths λ1 to λ5 and the wavelength λ1 is set at port #4, it is not possible to set the wavelength λ1 at port #5. If port #4 is released, the wavelength λ1 can be set at port #5.

Therefore, even in a case where the combination of port #5 and wavelength λ1 is registered in the unsettable wavelengths list, if port #4 is released, the entry for the combination of port #5 and wavelength λ1 is also deleted from the unsettable wavelengths list (see FIG. 14). Thus, when determining the settings contents for the next optical path, the path calculating apparatus 1 adds the wavelength λ1 to the usable wavelengths for port #5 and can take the addition of wavelength λ1 into consideration when determining the settings contents. Therefore, according to the first embodiment, the settings contents of an optical path can be determined using the unsettable conditions lists that are in accordance with the present state of the optical transport network.

Further, in the first embodiment, in a case where the reason for an error is included in a device setting error message, the path calculating apparatus 1 registers the error reason in the unsettable conditions lists. In a case where the reason for an error is not included in a device setting error message, the path calculating apparatus 1 registers the settings contents of a device setting command that corresponds to the device setting error message in the unsettable conditions lists. Thus, even in a case where the reason for an error is not clear in a device setting error message, the settings contents at the time of the error can be learned, and the occurrence of repeated transmission of a device setting command with the same settings contents can be suppressed.

As one item of the settings contents with respect to the NEs 3, the path calculating apparatus 1 determines a combination of two ports at which to set an optical cross-connect. Further, in a case where an error reason included in a device setting error message is that setting of an optical cross-connect is not possible, the path calculating apparatus 1 registers the combination of two ports for which setting of the optical cross-connect is not possible in the optical cross-connect unsettable ports list. When setting a new optical path, the path calculating apparatus 1 refers to the optical cross-connect unsettable ports list and determines setting ports for an optical cross-connect with respect to the relevant NE 3 in a manner that excludes combinations of ports that are registered in the optical cross-connect unsettable ports list. It is thereby possible to suppress the occurrence of repeated transmission of setting commands for setting an optical cross-connect with respect to a combination of two ports for which it is not possible to set an optical cross-connect to an NE 3 that has the combination of ports at which it is not possible to set an optical cross-connect as a device configuration constraint.

As one item of the settings contents with respect to the NEs 3, the path calculating apparatus 1 determines a wavelength to set at a port on the OCH side. Further, in a case where an error reason included in a device setting error message is that it is not possible to set a wavelength with respect to a designated port, the path calculating apparatus 1 registers the designated port and the wavelength that it is not possible to set in the unsettable wavelengths list. When setting a new optical path, the path calculating apparatus 1 excludes the wavelengths registered in the unsettable wavelengths list when determining a wavelength to be set at a port with respect to the NE 3. It is thereby possible to suppress the occurrence of repeated transmission of setting commands for setting a wavelength that it is not possible to set at a port to an NE 3 for which the fact that it is not possible to set the wavelength at the port is a device configuration constraint.

Further, designation of a signal type, that is, a transmission speed, is included in an optical path setting request from an external system. Furthermore, in a case where an error reason included in a device setting error message is that it is not possible to set a designated signal type at a designated port, the path calculating apparatus 1 registers the designated port and the designated signal type in the unsettable signal types list. When setting a new optical path, the path calculating apparatus 1 excludes a port at which it is not possible to set a signal type that is designated in the optical path setting request that is registered in the unsettable signal types list when determining a port at which to perform setting of an optical path with respect to the NE 3. It is thereby possible to suppress the occurrence of repeated transmission of setting commands for setting a signal type that it is not possible to set at a port to an NE 3 having a device configuration constraint that there is a signal type that it is not possible to set at the port.

According to the control apparatus, control method and control program of the present disclosure, the time taken to set a path in a network including an optical transmission device can be shortened.

### Recording Medium

A program for causing a computer or another machine or apparatus (hereinafter, “computer or the like”) to provide any of the above-described functions can be recorded into a recording medium that can be read by a computer or the like. The program in the recording medium is read into the computer or the like and executed, enabling provision of the function.

Here, the recording medium that can be read by the computer or the like refers to a non-transitory recording medium that can store information such as data and/or programs by means of electrical, magnetic, optical, mechanical or chemical action and can be read from the computer or the like. From among such recording mediums, ones that can be removed from the computer or the like include, for example, a flexible disk, a magnetooptical disk, a CD-ROM, a CD-R/W, DVD, a Blu-ray disk, a DAT, an 8 mm tape and a memory card such as a flash memory. Also, recording mediums fixed to the computer or the like include, e.g., a hard disk and a ROM (read-only memory). Furthermore, an SSD (solid state drive) can be used as either a recording medium that can be removed from the computer or the like or a recording medium fixed to the computer or the like.

All examples and conditional language provided herein are intended for the pedagogical purposes of aiding the reader in understanding the invention and the concepts contributed by the inventor to further the art, and are to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A control apparatus configured to transmit first settings information including first settings contents with respect to an optical transmission device, comprising:
a processor and a storage,
wherein the processor is configured to:
receive a setting error with respect to the first settings information from the optical transmission device;
store a setting condition of the optical transmission device in the storage, the setting condition acquired from the setting error;
determine second settings contents relating to transmission of an optical signal to the optical transmission device based on the stored setting condition; and
transmit second settings information including the second settings contents to the optical transmission device.

2. The control apparatus according to claim 1, wherein:
the processor is configured to determine, for optical transmission devices on a route of an optical path, settings contents relating to the optical path as the second settings contents based on the setting condition in the storage.

3. The control apparatus according to claim 1, wherein:
the processor is configured to receive a notification of a configuration change from the optical transmission device, and
update the setting condition in the storage in accordance with contents of the notification of a configuration change.

4. The control apparatus according to claim 1, wherein:
the processor is configured to acquire a reason for an error as the setting condition when the reason for the error is included in the setting error, and acquire the first settings contents relating to transmission of an optical signal as the setting condition when a reason for an error is not included in the setting error, the first settings contents included in the first settings information corresponding to the setting error.

5. The control apparatus according to claim 2, wherein:
the first settings information includes at least settings information regarding an optical cross-connect between two ports within the optical transmission device; and
the processor is configured to acquire, as the setting condition, information to an effect that it is not possible to set the optical cross-connect between the two ports specified by the first settings information which corresponds to the setting error, and determine the second settings contents not to include information of the optical cross-connect between the two ports for which it is not possible to set the optical cross-connect.

6. The control apparatus according to claim 5, wherein:
the first settings information includes settings information regarding a wavelength to a first port configured to output a single wavelength signal obtained by separating a WDM (Wavelength Division Multiplexing) signal into respective wavelengths, the first port being a port among two ports that are object of setting of an optical cross-connect; and
the processor is configured to acquire, as the setting condition, information to an effect that it is not possible to set the wavelength at the first port specified by the first settings information corresponding to the setting error that is received, and determine the second settings contents not to include the wavelength that it is not possible to set as a wavelength that is set at the first port.

7. The control apparatus according to claim 5, wherein:
the first settings information includes settings information regarding an output speed of the optical signal to a first port configured to output a single wavelength signal obtained by separating a WDM (Wavelength Division Multiplexing) signal into respective wavelengths, the first port being a port among two ports that are object of setting of an optical cross-connect; and
the processor configured to acquire, as the setting condition, information to an effect that it is not possible to set an output speed of the optical signal to the first port specified by first settings information corresponding to the setting error, and determine the second settings contents not to include the output speed that it is not possible to set as the output speed of the optical signal that is set at the first port.

8. A control method, comprising:
a control apparatus that is configured to transmit first settings information including first settings contents with respect to an optical transmission device:
receiving a setting error with respect to the first settings information from the optical transmission device;
storing a setting condition of the optical transmission device that is acquired from the setting error in a storage;
determining second settings contents relating to transmission of an optical signal with respect to the optical transmission device based on the stored setting condition; and
transmitting second settings information including the second settings contents to the optical transmission device.

9. A non-transitory computer-readable recording medium with control program recorded thereon that causes a control apparatus configured to transmit first settings information including first settings contents with respect to an optical transmission device to:
receive a setting error with respect to the first settings information from the optical transmission device;
store a setting condition of the optical transmission device that is acquired from the setting error in a storage;
determine second settings contents relating to transmission of an optical signal with respect to the optical transmission device based on the stored setting condition; and
transmit settings second information including the second settings contents to the optical transmission device.
